(19) United States
(12) Patent Application Publication
(10) Pub. No.: US 2018/0353828 A1
(43) Pub. Date: Dec. 13, 2018

(54) Method and apparatus for ball flight analysis

(71) Applicants: Leslie Otten, Greenwood, ME (US); Charles Wilkins, IV, Peru, ME (US); Norman Clanton, Newry, ME (US); Christopher Bennet, Nashua, NH (US)

(72) Inventors: Leslie Otten, Greenwood, ME (US); Charles Wilkins, IV, Peru, ME (US); Norman Clanton, Newry, ME (US); Christopher Bennet, Nashua, NH (US)

(73) Assignee: Golftech, LLC

(21) Appl. No.: 15/731,429

(22) Filed: Jun. 9, 2017

(51) Int. Cl. A63B 69/36; G01P 3/36; G01B 11/26; A63B 24/00; A63B 71/06; H04N 7/18; H04N 5/225

(52) U.S. Cl. CPC A63B 69/3658; G01P 3/36; G01B 11/26; A63B 24/0003; A63B 24/0021; A63B 71/0622; A63B 69/0002; H04N 5/2256; A63B 2220/803; A63B 2220/30; A63B 2220/807; A63B 2220/62; A63B 69/3661; H04N 7/188

(57) ABSTRACT

A ball flight analysis system includes a strobe device, such as an infrared strobe device, to illuminate a ball in flight. An imaging device captures a plurality of images of the ball in flight, for example, within a single frame. A processor determines from the plurality of captured ball images one or more flight characteristics of the ball, such as the ball's velocity or ball's angular velocity and axis of rotation.

### FIELD

Inventive concepts relate to systems and methods to aid in analyzing flight characteristics of a struck object, such as ball used in a sports activity. More particularly, inventive concepts relate to a system and method for detecting and analyzing the path and orientation of a ball, such as a golf ball. Although the present invention is well suited to the analysis of the flight of a golf ball, inventive concepts are not limited thereto and may be used, for example, for analysis of the flight of a baseball (whether hit or pitched), tennis ball, or ping pong ball.

### BACKGROUND

A ball-flight analysis system may be used for analyzing a sports-swing or throw, by extrapolating back from flight characteristics of a ball. For example, the spin of a struck or thrown baseball, or of a struck golf ball, may provide information regarding whether the ball was “topped,” or otherwise mis-struck or mis-thrown. Alternatively, a ball-flight analysis system may be used to simulate an actual ball flight path, for example, in a simulated game or training session. In a confined space such as an indoor golf facility, flight characteristics such as speed, spin, or launch angle of a struck golf ball may be captured in the first few feet of flight and the analyzed characteristics may be used to simulate the flight of the ball, thereby providing feedback to a practicing golfer or to simulate the flight of a ball in a virtual golf course, for example.

Although professionals are available to help athletes improve their swings (e.g., hitting coaches for baseball players and golf and tennis professionals), costs associated with such lessons are beyond the means of the vast majority of players. Scheduling the time for and traveling to lessons adds another layer of inconvenience to this approach for improving your golf game. Additionally, athletic activities involving the use of an implement moving at a high rate of speed make it difficult to accurately assess any flaws in the mechanics of an individual's swing.

Devices and systems are available for sport participants to make critical evaluations of the techniques and mechanics associated with their sport of interest. In the sport of golf there have been a number of advances in golf club swing analysis. For example, U.S. Pat. No. 5,718,639 issued to Bouton, U.S. Pat. No. 5,474,298 issued to Lindsay, and U.S. Pat. No. 6,227,984 issued to Blankenship, disclose various approaches to sensing and analyzing golf swings. Notwithstanding the abundance of swing analysis systems, the development of accurate, inexpensive swing sensing and analysis systems remains elusive.

An automated system that analyzes a sport swing and provides feedback to a player as a convenient, accurate, low-cost alternative to the engagement of coaches and/or professionals would be highly desirable.

Although, for the sake of conciseness and clarity, example embodiments may generally be directed to the analysis and simulation of a golf ball's flight, inventive concepts are not limited thereto and may be applied, for example, to baseballs, tennis balls, or other balls, as well.

### SUMMARY

In example embodiments a ball flight analysis system and method in accordance with the principles of inventive concepts may capture a plurality of images of a ball in flight and analyze those images to determine at least one flight characteristic of the ball. The system may employ a trigger, an illumination source, an imager, an analyzer and a user interface.

In example embodiments a ball flight analysis system in accordance with principles of inventive concepts may employ a trigger responsive to movement to activate an illumination source that employs a strobed infrared (IR) light. In such embodiments an infrared imaging device, which may include an IR filter, captures images of a ball in flight and an analyzer analyzes the plurality of images to determine one or more ball flight characteristics, such as ball speed, ball launch angle, ball rotation direction, and ball spin (for example, in revolutions per minute (RPM)). The system may employ such flight characteristics to provide feedback to a user, through the user interface, or may employ the flight characteristics to simulate a ball's flight and to couple the ball's simulated flight path to a simulated game or training session, for example.

In example embodiments in accordance with principles of inventive concepts, a ball flight analysis system includes a strobe device, such as an infrared strobe device, to illuminate a ball in flight. An imaging device captures a plurality of images of the ball in flight, for example, within a single frame. A processor determines from the plurality of captured ball images one or more flight characteristics of the ball, such as the ball's velocity or ball's angular velocity and axis of rotation.

In example embodiments in accordance with principles of inventive concepts, an apparatus includes a strobe device configured to illuminate a ball in flight, an imaging device configured to capture an image of the illuminated ball in flight; and a processor configured to determine a flight characteristic of the ball in flight from the captured image.

In example embodiments in accordance with principles of inventive concepts, an apparatus includes a triggering device to detect motion related to the flight of the ball and to trigger the strobe device and imaging device.

In example embodiments in accordance with principles of inventive concepts, an apparatus includes a strobe device configured to illuminate the ball using electromagnetic radiation outside the visible spectrum.

In example embodiments in accordance with principles of inventive concepts, an apparatus includes a processor configured to determine flight characteristics such as ball velocity, ball launch angle, and ball spin.

In example embodiments in accordance with principles of inventive concepts, an apparatus includes a processor configured to simulate the flight of the ball along a path beyond a field of view of the imaging device.

In example embodiments in accordance with principles of inventive concepts, an apparatus includes a processor configured to simulate a game using the simulated flight of the ball.

In example embodiments in accordance with principles of inventive concepts, an apparatus includes a processor configured to determine the speed of the ball from a plurality of strobe images of the ball captured in one frame of the imaging device.

In example embodiments in accordance with principles of inventive concepts, an apparatus includes a processor configured to determine the angular velocity and axis of rotation of the ball from a plurality of strobe images of the ball captured in one frame of the imaging device.

In example embodiments in accordance with principles of inventive concepts, an apparatus includes a processor configured to employ fiducial marks on the ball in the plurality of strobe images of the ball captured in one frame of the imaging device to determine the angular velocity and axis of rotation of the device.

In example embodiments in accordance with principles of inventive concepts, a method includes illuminating a ball in flight with a strobe device, capturing an image of the strobe-illuminated ball in flight with an imaging device, and a processor determining a flight characteristic of the ball in flight from the captured image.

In example embodiments in accordance with principles of inventive concepts, a method includes a triggering device detecting motion related to the flight of the ball and triggering the strobe device and imaging device.

In example embodiments in accordance with principles of inventive concepts, a method includes the strobe device illuminates the ball using electromagnetic radiation outside the visible spectrum.

In example embodiments in accordance with principles of inventive concepts, a method includes a processor determining a flight characteristic of the ball from among: ball velocity, ball launch angle, and ball spin.

In example embodiments in accordance with principles of inventive concepts, a method includes a processor simulating the flight of the ball along a path beyond a field of view of the imaging device.

In example embodiments in accordance with principles of inventive concepts, a method includes a processor simulating a game using the simulated flight of the ball.

In example embodiments in accordance with principles of inventive concepts, a method includes a processor determining the speed of the ball from a plurality of strobe images of the ball captured in one frame of the imaging device.

In example embodiments in accordance with principles of inventive concepts, a method includes a processor determining the angular velocity and axis of rotation of the ball from a plurality of strobe images of the ball captured in one frame of the imaging device.

In example embodiments in accordance with principles of inventive concepts, a method includes a processor employing fiducial marks on the ball in the plurality of strobe images of the ball captured in one frame of the imaging device to determine the angular velocity and axis of rotation of the device.

In example embodiments in accordance with principles of inventive concepts, a golf system includes an infrared strobe device configured to illuminate a golf ball in flight, an infrared imaging device configured to capture a plurality of images of the illuminated ball in flight within one frame of the imaging device, and a processor configured to determine the speed of the golf ball in flight from the plurality of captured images by temporally organizing the captured images and associating the times of the captured images with times of the infrared strobe to establish a time difference between captured images, determining the pixel distance between captured images, and employing the pixel distance and time difference to determine the speed of the ball.

In example embodiments in accordance with principles of inventive concepts, a golf system includes a processor configured to correct for lens distortion, for apparent speed shift of the ball as it moves through the imaging device's field of view, and for apparent rotational shift of the ball as it moves through the imaging device's field of view.

### BRIEF DESCRIPTION OF THE DRAWINGS

The above and further features, aspects, and advantages of the invention will be apparent to those skilled in the art from the following detailed description, taken together with the accompanying drawings in which:

FIG. 1 is a block diagram of an example embodiment of a ball flight analysis system in accordance with principles of inventive concepts;

FIG. 2 is a flowchart of an example method of analyzing ball flight in accordance with principles of inventive concepts;

FIG. 3 is a perspective view of an example embodiment of a ball flight analysis system in accordance with principles of inventive concepts;

FIG. 4 is a perspective view of an example embodiment of an illuminating/imaging device in accordance with principles of inventive concepts;

FIG. 5 is a flowchart of an example embodiment of a method of determining ball flight characteristics in accordance with principles of inventive concepts;

FIGS. 6A through 6B illustrate an example of image subtraction in accordance with principles of inventive concepts;

FIG. 7 illustrates an example implementation of blob detection in accordance with principles of inventive concepts;

FIGS. 8 through 12 illustrate an example of location of smooth ball edges in accordance with principles of inventive concepts;

FIG. 13 is an example of an in-flight image of a ball in flight in accordance with principles of inventive concepts;

FIG. 14 illustrates non-ball elements of an image masked off in accordance with principles of inventive concepts;

FIG. 15 illustrates fiducials from both in-flight and background-subtracted images in accordance with principles of inventive concepts;

FIG. 16 illustrates apparent rotation of a ball, which is compensated for in accordance with principles of inventive concepts;

FIGS. 17A through 17D illustrate the selection of fiducial triangles in accordance with principles of inventive concepts;

FIGS. 18A and 18B illustrate the tracking of a fiducial triangle in accordance with principles of inventive concepts;

FIGS. 19A-19I are conceptual diagrams further illustrating the tracking of fiducials in accordance with principles of inventive concepts;

FIGS. 20-24 are conceptual diagrams of the determination of a ball's rotation characteristics using fiducials in accordance with principles of inventive concepts;

FIGS. 25A, 25B, and 26 are illustrative embodiments of fiducial patterns in accordance with principles of inventive concepts;

FIG. 27 is a screenshot of an example embodiment of a system in accordance with principles of inventive concepts including ball flight characteristics;

FIG. 28 is a screenshot of a simplified graphical interface such as may be employed by a system in accordance with principles of inventive concepts;

FIG. 29 is a detailed view of view of a display of information such as may be included in the display of FIG. 28;

FIG. 30 is a screenshot of a system in accordance with principles of inventive concepts indicating that ball rotation information has not been computed successfully; and

FIG. 31 is a block diagram of a processor such as may be employed by a system in accordance with principles of inventive concepts.

### DETAILED DESCRIPTION

Inventive concepts will now be described more fully hereinafter with reference to the accompanying drawings, in which example embodiments of inventive concepts are shown. The advantages and features of the inventive concepts and methods of achieving them will be apparent from the following example embodiments that will be described in more detail with reference to the accompanying drawings. It should be noted, however, that the inventive concepts are not limited to the following example embodiments, and may be implemented in various forms. Accordingly, the example embodiments are provided only to disclose the inventive concepts and let those skilled in the art know the category of the inventive concepts. In the drawings, embodiments of the inventive concepts are not limited to the specific examples provided herein and are exaggerated for clarity.

The terminology used herein is for the purpose of describing particular embodiments only and is not intended to limit inventive concepts. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof, or a different ordering of steps.

Additionally, an embodiment in the detailed description will be described with sectional views as ideal exemplary views of the inventive concepts. Accordingly, shapes of the exemplary views may be modified according to manufacturing techniques and/or allowable errors. Therefore, the embodiments of the inventive concepts are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concepts.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present inventive concepts. Example embodiments of aspects of the present inventive concepts explained and illustrated herein include their complementary counterparts. The same reference numerals or the same reference designators denote the same elements throughout the specification.

A ball flight analysis system in accordance with the principles of the present invention may be configured and employed to analyze the characteristics of a ball's flight, for training or entertainment purposes. Although the system may be employed for any number of sports that incorporate a ball in flight, such as baseball, tennis, soccer, or golf, the following detailed description will concentrate, for the sake of brevity and clarity of exposition, on the detection, analysis, and simulation of the flight of a golf ball.

In example embodiments a ball flight analysis system and method in accordance with the principles of inventive concepts may capture a plurality of images of a ball in flight and analyze those images to determine at least one flight characteristic of the ball. The system may employ a trigger, an illumination source, an imager, an analyzer and a user interface.

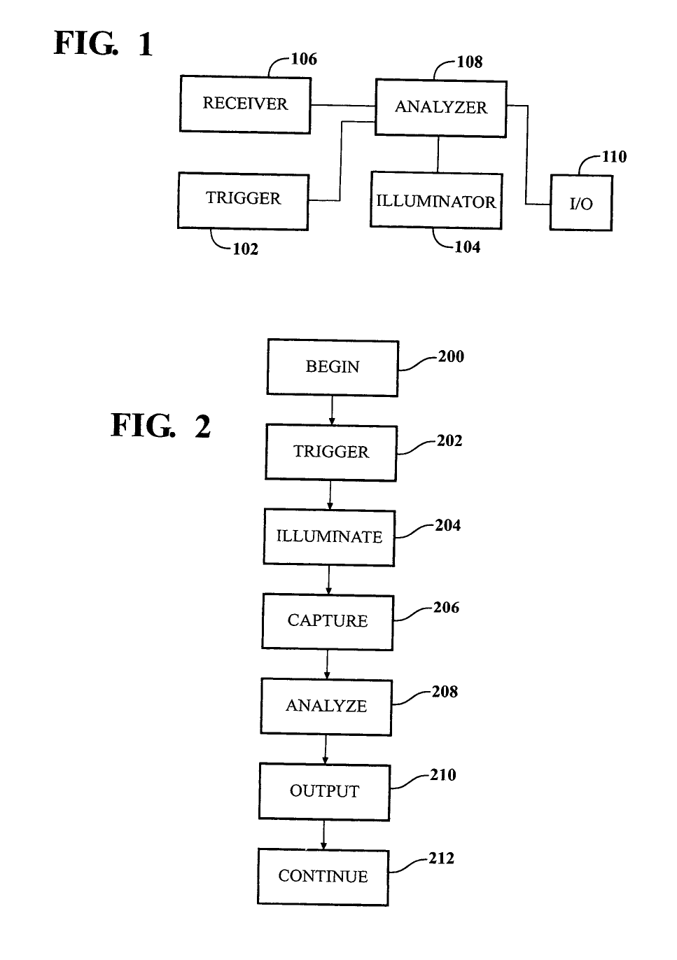

In example embodiments a ball flight analysis system 100 in accordance with principles of inventive concepts, as illustrated in the conceptual block diagram of FIG. 1, may employ a trigger 102 responsive to movement to activate an illumination source 104 that employs a strobed infrared (IR) light. In such embodiments an infrared imaging device 106 captures images of a ball in flight and an image analyzer 108 analyzes the plurality of images (or a single image, with a plurality of ball “snapshots”) to determine one or more ball flight characteristics, such as speed, launch angle, or spin (which may be in terms of spin rate and spin direction), for example. System 100 may employ such flight characteristics to provide feedback to a user, through the user interface 110, and may employ the flight characteristics to simulate a ball's flight and to couple the ball's simulated flight path to a simulated game or training session through the user interface 110, for example. As noted above, although system 100 may be employed for wide variety of ball analyses and simulations, this description will focus, primarily, on a description related to golf balls and simulations related to golf training or a simulated golf game. A simulated game may, for example, be conducted locally, through a single user interface 110 that displays a simulated golf game on a single display, or may be conducted, via a network such as the Internet, in a distributed manner, with opposing players located anywhere in the world with access to such a network.

The flow chart of FIG. 2 illustrates a process in accordance with principles of inventive concepts by which ball flight analysis is conducted. The process begins in step 200 and proceeds from there to step 202, where the ball flight analysis process is triggered. Any of a variety of triggering mechanisms may be employed; an illustrative example of a triggering mechanism will be described in greater detail below. After triggering in step 202, the process proceeds to step 204, where the area, or field of view, through which the ball is to travel is illuminated by a strobe light. In example embodiments, the strobe provides light from outside the visible range, in the infrared range. Illumination of the field of view will be described in greater detail below.

In step 206 multiple “sub-images” of the ball in flight are captured, for example, by an imager sensitive to the range of wavelengths provided by the illumination source (for example, an IR strobe light in example embodiments). With the aperture of the imager remaining open for a period of time sufficient to capture multiple strobe events, but not so long as to over-expose or otherwise degrade the resultant image, the imager captures multiple strobed “sub-images” of the ball in flight in a single exposure. To avoid awkward language, we may refer to an exposure as an image, and to each of the “sub-images” within an exposure as an image; the meaning of the usage should be clear from context. The imager and imaging process will be described in greater detail below.

After capturing an image in step 206, the process proceeds to step 208, where the captured image is analyzed to derive one or more flight characteristics of the ball. The analysis may be carried out by a single processor or may be distributed over multiple platforms. The analysis process and a processor 3100 will be described in greater detail below.

After analyzing the captured image(s) in step 208, the process proceeds to step 210, where the results of the analysis are output. The output may take any number of forms (for example, a graphic image of a ball with flight characteristics superimposed, an animated ball flying according to the flight characteristics, or feedback provided to a user, in the form of swing suggestions), and will be described in greater detail below.

After outputting the analysis results, the process may proceed to end or continue in step 212, with the option of continuing to analyze more ball flights (for example, during a simulated game) as a default and ending the analysis at the request of a user in example embodiments.

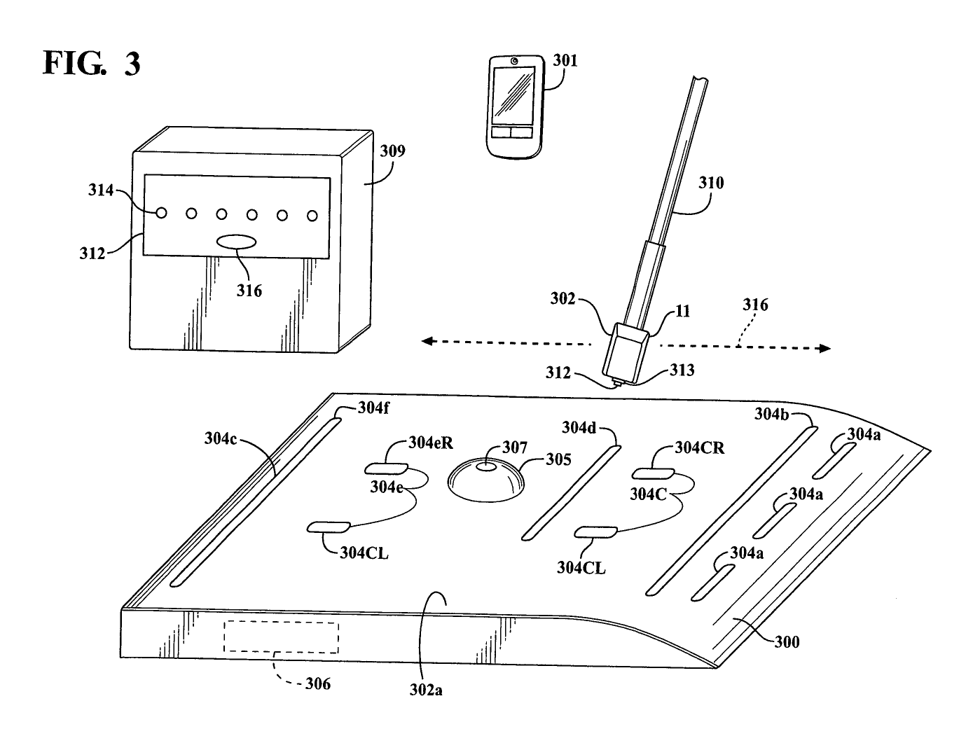

The perspective view of FIG. 3 is of an illustrative physical layout of a golf ball flight analysis system 100 in accordance with principles of inventive concepts. In this illustrative embodiment gold club 310 is shown on the same side of the system as housing 309 for convenience, but, in fact a user stands on the opposite side of the balls as housing 309. As previously indicated, a system and method in accordance with principles of inventive concepts may be employed in the analysis of various ball flight characteristics (for example, a hit baseball, a thrown baseball, a hit tennis ball, or a hit golf ball), but the detailed description will be addressed primarily to analysis of golf ball flight characteristics and application to other ball analyses will be readily extrapolated therefrom. In this example embodiment, system 100 includes a ball support platform 300 that provides a triggering output that substantially coincides with the time at which a golf ball is struck. In this example embodiment imaging housing 309 includes an IR strobe light (or array) 314 and IR imaging device 316 facing through opening 312 substantially perpendicular to the flight path of a golf ball, which may be situated atop a tee placed within opening 307. The IR strobe 314 and IR imaging device 316 will be described in greater detail below. For now, a more detailed description of a sensor housing 302 and its components, which may provide, for example, a trigger (which may be communicated through a wired or wireless link) to the IR strobe 314 and IR imaging device 316, will be described in greater detail

In example embodiments, system 100 includes a sensor housing 302 or equivalent structure for containing therein a plurality emitters and detectors. In an example embodiment in accordance with principles of inventive concepts, the emitters and detectors are arranged into six groups, or arrays, identified by reference numerals 304a, 304b, 304c, 304d, 304e, and 304 f. The system 100 further includes signal generation and processing components 306 contained, in this example embodiment, within the housing 302. In an example embodiment, the signal generation and processing components are coupled to the emitters and detectors (304a-304f) and to a processor 3100, which may be positioned within platform 302, within housing 309, or in a standalone configuration, for example, as a general purpose computer.

A golf club 310 having retroreflective material 312 coupled to it is swung by a user over the housing 302 in order to capture data for analysis of the user's golf swing, and for providing various forms of feedback to the user by the system 100. A mat may be employed to provide a level, resilient, grass-like surface upon which a user may stand. The mat simulates the look and feel of a golf course surface and, with a thickness approximately the same as the thickness of the housing 302, positions a user level with the upper surface 302a of the housing 302. The illustrative system 100 also includes a net which may be positioned to capture golf balls hit by a user.

Retroreflective material, such as used in this example embodiment, is familiar to most people through its use in traffic signs. The material provides the unique property of returning light to a light source, rather than, as with conventional reflective material, reflecting light according to the familiar, “angle of incidence equals the angle of reflection,” rule. Retroreflective materials are typically one of two types: enclosed-lens, glass bead sheeting, or microprismatic, “cube-corner,” reflective material. “Glass bead” sheeting features a complex construction of many laminated layers. Thousands of microscopic glass beads are embedded per square inch in these layers. Sandwiched between the adhesive and bead layers, a metalization layer is closely molded to the contoured backside of the beads, and acts as a reflector. Light passes through the film's top layers and strikes this layer. Bouncing off the metalization layer, light returns through the beads back through to the light source. Microprismatic retroreflective material uses an embossed geometric pattern on the sheeting's interior surface to refract the light beam. By bouncing the light off different planes of the pattern, the light is redirected back to its origin. Various retroreflective film types are available from manufacturers, such as 3M corporation, Saint Paul, Minn.

The illustrative sensor housing 302 may be fabricated of a resilient material, with the emitters and detectors (304a-304f) embedded therein. In this example embodiment, the emitters and detectors are reflective type sensors wherein the detectors produce a signal proportional to the amplitude of light they detect of the wavelength emitted by the emitters. Typically, background radiation will contribute to a signal at one or more of the detectors, but the system 100 employs signal processing techniques to eliminate the effects of such “artifacts.” This example embodiment employs QED123 and QSD123 emitters and detectors, respectively, available from Fairchild Semiconductors. The housing 302 is primarily composed of opaque material, with ports formed in the upper surface 302a of the housing 302 at the locations of the sensors 304a-304f. In this example embodiment, each of the sensors may be thought of as an emitter/detector pair. Emitters within a group of sensors will be referenced by the addition of an “e” to the respective sensor's reference number, and detectors will be referenced by the addition of a “d” to the respective sensor's reference number. For example, emitters within the 304a sensor group will be associated with reference numeral 304ae and, similarly, detectors within the 304a sensor group will be associated with the reference numeral 304ad.

In use, the housing 302 is positioned such that when a golf club 310 is swung, the head of the golf club 310 travels along a swing path 316 that passes over the housing upper surface 302a. Specifically, the swing path 316 passes over the housing back edge 302b, one or more of the sensors (304a-304f), and then the housing front edge 302c. A ball support 305 will directly support a golf ball substantially at the level of the housing upper surface 302a, to simulate the positioning of a ball while putting or, in general, during any shot other than a tee shot. Additionally, the ball support 305 is configured to accept a golf tee and to thereby permit a golfer to take a tee shot.

In this example embodiment, the emitters and detectors of sensors 304a-304f respectively emit and accept relatively narrow beams of infrared light. The properties of the reflective material 312 coupled to the head of the club 310 permit the use of relatively narrow beams, which, in turn, provides greater accuracy in detecting the presence or absence of the head of a club 310 above the housing 302. In the example embodiment, the emitted light forms a beam with a spread of approximately 22 degrees. The detectors are sensitive over a comparably narrow range. Such a narrow beam allows the system 100 to distinguish smaller features over a greater distance than otherwise would be the case. Consequently, the accuracy and resolution of the system is increased concomitantly. With a conventional reflective surface, the reflected energy would only activate the detectors if the reflecting surface were substantially perpendicular to the central beam of the incident light energy. Additionally, a change in orientation relative to horizontal would appear as a horizontal shift in position if a conventional reflective surface were employed. In this example embodiment, the reflective material 312 is a retroreflective tape that is applied to the bottom of the head of the club 310.

In operation, light transmitted by an emitter only returns to a nearby, associated, detector when it is reflected by an object, such as the retroreflective tape 312. As a club 310 is swung along the swing path 316, light from one or more of the emitters 304ae-304fe is reflected back to one or more of the detectors 304ad-304fd by the reflective strip. Additionally, light from the emitters 304ae-304fe is substantially absorbed before and after passage of the reflective strip 312 by the absorbent material 313 which, in this illustrative example, substantially surrounds the reflective strip 312. The contrast between high levels of absorption and high levels of reflectivity provides for a sharp transition in reflected light amplitude that a system in accordance with the principles of the present invention may use to clearly distinguish the passage of a club head from fluctuations in light amplitude not due to the passage of a club head and, therefore, not relevant to a sports swing analysis system. Not only does the sharp contrast provided by the combination of absorbent and reflective materials distinguish such background fluctuations from light amplitude transitions of interest, it also allows the system 100 to determine with some precision the exact time at which the edge of the retroreflective material passes over a sensor and, therefore, permits the system to more accurately determine the values of swing parameters of interest, such as: swing path angle, club head speed, club head angle, club head lateral alignment with respect to a ball support, and club head height.

The array of sensors 304a operate as triggers. That is, in example embodiments, power is constantly applied to the emitters and detectors so that the sensors may detect the passage of a club head at any time. When a trigger event is detected by sensors in the trigger row 304a, the remaining sensors, in particular the emitters of the remaining sensors, are turned on at full power for a period of time that is sufficient to capture swing data. Contact row sensors 304d are positioned in close enough proximity to a ball support 305 to obtain club head data approximately at the time of the club's impact with a ball. That is, the trailing edge of a properly placed reflective strip will be detected substantially coincident with the striking of the ball. Sensor arrays 304c and 304e are used to evaluate club head toe and club head heel height before and after the point of impact, which provides further information on how the ball is struck relative to the sweet spot of the club head face. Club head toe and heel height are determined using a technique that is a variation on standard triangulation for distance determination. In an example embodiment, the sensors are angled approximately 30 degrees with respect to a line perpendicular to the upper surface of the housing 302a. However, it will be understood that the sensors could be oriented at any reasonable angle, for example, from 15 degrees to 75 degrees. Note that, without the retroreflective surface, the angled beams would not activate their respective detectors.

Since each of the sensors arrays 304c and 304e include two parallel rows (304c1 and 304cr, and 304el and 304er, respectively) effectively situated an equal distance on either side of the tee, for a right handed golfer swinging in the direction indicated by the path 316, the height of the toe of the club is measured by sensor rows 304cr and 304er, and the height of the heel of the club is measured by sensor rows 304cl and 304el. This configuration enables the club head toe and heel heights to be measured independently, which, in turn, enables the system to provide a more accurate depiction of the swing, as is described below.

Sensors are arranged within the housing as follows. Sensors 304a are positioned at the trigger row of the housing. The sensors 304a include three emitter/detector pairs. One of the emitter detector pairs is positioned along a center line that it shares with the ball support 305. The other two of the emitter/detector pairs are equally spaced on either side of the middle emitter/detector pairs. Among other functions, this group of sensors 304a operates as a “trigger” for the remaining sensors, applying power to the emitters of the remaining sensors only when a trigger event, indicating the passage of a golf club head, has occurred.

A linear array of eleven emitters and ten detectors 304b is positioned transverse to the golf club swing path approximately 1.25 inches closer to the golf ball support 305 than the trigger array of sensors 304a. This array 304b is the entrance row of sensors. Angled sensor array 304c is arranged with two pairs of emitters and detectors, each pair parallel to the major axis of the housing 300, with a pair aligned to either side of the ball support 305. In an example embodiment the angled emitter detectors are positioned at an angle of 30 degrees with the upper surface 302a of the housing 300. Such an alignment permits a system in accordance with the principles of the present invention to determine the height of a club head as it passes overhead.

The array 304d of four emitters and five detectors is positioned transverse to the club swing path approximately four inches closer to the ball support than the trigger array 304a. This, the contact row of sensors, is positioned close enough to the ball support 305 to detect club swing information coincident with, or just before, contact between a club face and the golf ball. That is, being within 1.5 inches of the support 305 in the example embodiment, the trailing edge of the retroreflective strip passes over the array substantially concurrent with the time the ball is being struck and, consequently, data related from that array is data at the time of impact.

Another angled sensors array 304e is arranged with two pairs of emitters and detectors, each pair parallel to the major axis of the housing 300, with a pair aligned to either side of and equidistant from the major axis that passes through the center of the ball support. Additionally, in this example embodiment, the angled arrays 304c and 304e are positioned an equal distance, d, of approximately three and one half inches to either side of the ball support 305 and perpendicular to the major axis of the housing 300. An exit row of sensors 304f includes eleven emitters and ten detectors arranged transverse to the club swing path 316 and a distance d2 approximately four and one half inches from the ball support 305 (that is, approximately the same distance from, but on the opposite side of, the ball support as the sensor array 304b). In this example embodiment, a signal light in the form of an LED 304g is positioned in close proximity to the center of the three emitter/detector pairs that form the sensor array 304a. This embodiment of a sports swing analysis system employs the LED to indicate to a user whether the user is operating in a “slow swing” mode or not.

The ball support 305 may directly support a ball, for example, when a golfer is operating the system in a slow swing mode, or, with the insertion of a tee into the hole 307 within the ball support by a golfer, the ball support 305 may support a tee which, in turn, supports the ball. The output of the entrance row 304b and exit row 304f sensors is used to determine the club's swing path angle and the club head's lateral alignment with the ball. The system employs a combination of parameter values, including swing path angle, lateral alignment, and face angle, to indicate whether the ball has been struck on the center of the club head face (that is, the sweet spot) or if the ball has been struck on the heel or toe of the club head.

In example embodiments, a system 100 may employ all the features provided by the emitters and receivers in platform 300, such as the club's swing path angle and the club head's lateral alignment with the club swing path angle, lateral alignment, and face angle, to indicate whether the ball has been struck on the center of the club head face (that is, the sweet spot) or if the ball has been struck closer to the heel or toe of the club head. The system may employ the triggering mechanism provided by platform 300 to activate IR strobe 314 and IR imager 316, or it may employ a different triggering mechanism. That is, system 100 may provide features just described in conjunction with operation of platform 300, along with golf ball flight analytics and simulation to be described in detail below, employing the triggering mechanism just described, it may provide the features just described in lieu of the golf ball flight analytics to be described below (as a backup, for example, should imaging fail), it may employ the functionality of platform 300 merely for triggering, or it may employ a different triggering mechanism altogether.

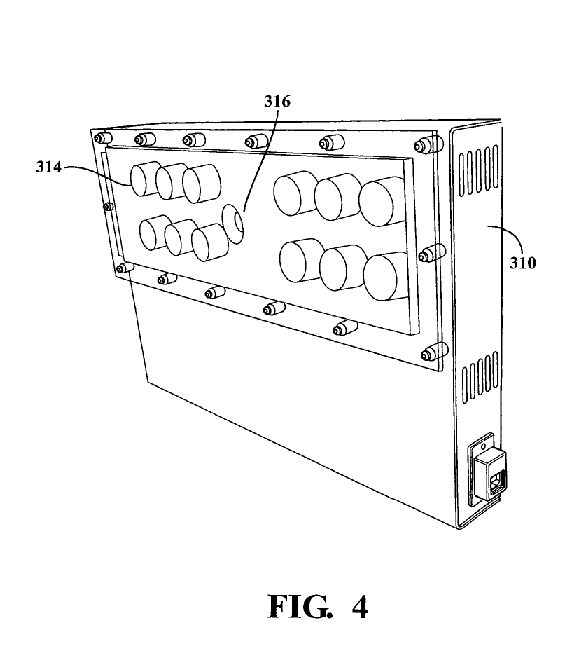

The perspective view of FIG. 4 provides a more detailed view of the IR strobe 314, IR imager 316 and imager housing 309. In example embodiments, IR strobe 314 employs a cluster of twelve 730-740 nm IR LEDs to provide adequate illumination for IR imager 316. IR imager 316 may be implemented, for example, as a low power USB camera, such as a See3CAM USB camera. Such cameras are known and available, for example, from e-con Systems and, in particular, model India PVTLtd See3CAM 10_CUG_MH. In example embodiments, an IR phototransistor (for example, a QSD123) may be employed as a trigger mechanism to simultaneously activate IR imager 316 and IR strobe 314. The IR phototransistor may be used in addition to, or as a substitute for a trigger signal received from system platform 300, as previously described, and may be mounted on platform 300 to receive trigger reflections from QED123 phototransistors mounted in platform 300. Upon triggering, IR strobe 314 illuminates the ball flight path a plurality of times during a single exposure of IR imager 316.

In example embodiments imager 316 captures multiple images of a marked golf ball in flight in one exposure. The golf ball is illuminated a plurality of times during the single exposure time by IR strobe 314. As will be described in greater detail below, in an example embodiment processor 3100 may employ image subtraction to capture changes in ball position through time, after the ball is struck. Image subtraction techniques may eliminate background imagery, particularly of relatively stationary objects, such as a user striking a golf ball, for example. As will be described in greater detail below, processor 3100 may determine from the multiple golf ball images: the ball's launch angle, the ball's speed, the ball's angular velocity (in revolutions per minute (RPM) and axis of rotation, for example. As will be described in greater detail below, the strobe rate of IR strobe 314 may be set and adjusted via a link, such as a USB link, that allows for adjustment of strobe rate and strobe duration, number of pulses and frequency of pulses, for example, in order to ensure that a sufficient number of ball images are obtained during a ball's flight. In an example embodiment, the IR imager system (housing 309, IR strobe 314, and IR camera 316) may be arranged, as shown in FIG. 2, approximately twenty-four inches to the side of the ball (or support 207) and twelve inches forward of the ball (or support 207). With this geometric arrangement, the field of view of the IR imager 316 is approximately four feet across along the path of the ball's flight. That is, corresponding to the center longitudinal axis of platform 300, which coincides with the path of the ball's flight, assuming the ball does not substantially deviate from a straight flight path over the four feet.

In an example embodiment IR imager 316 is placed in a trigger mode, for example, by a processor in platform 300 or in a computing device 301, such as a desktop computer, tablet computer, phablet, or smartphone, for example, which includes a processor 3100 3100 and user interface 110. The processor may configure camera settings such as, focus, exposure, still image resolution, still image storage location, etc. In trigger mode the IR imager 316 initiates exposure in response to a trigger signal, obtained, for example, from trigger 102. A processor 3100 may provide sufficient scan time to monitor input frequencies (in a range around 880 nm in an example embodiment) required to respond to a golf club swing input signal from a trigger phototransistor In example embodiments, IR strobe 314 may produce a pulsed output of fifty microseconds on time and fifty microseconds off time, which may be adjustable, as described in greater detail below. Processor 3100 may control IR strobe 314 by providing three parameter values before each golf swing: 1) strobe on time (for each pulse), 2) strobe off time, or width between pulses, (for each pulse), and 3) the number of pulses.

A system in accordance with principles of inventive concepts may employ a plurality of modes of operation in order to accommodate a variety of ball speeds. In an example embodiment, with a camera field of view of four feet in width, a ball driven at four miles per hour (while putting, for example) transits the four feet in five hundred forty five milliseconds. A ball driven at one hundred seventy miles per hour transits the four feet in sixteen milliseconds. Using two modes, a putting speed and a driving speed, for example, a system in accordance with principles of inventive concepts may tailor IR pulse settings (for example, pulse on and off time and number of pulses) to best suit different ball speeds. In an example embodiment a system in accordance with principles of inventive concepts may operate on information that allows the system to automatically adjust IR pulse settings, for example, by employing information related to a user's position within a simulated game (whether on the tee or on the green, for example). In accordance with principles of inventive concepts, a user may, alternatively or additionally, enter the type of club in use (a four iron, for example) and the system may adjust the IR pulse rate and duration accordingly to ensure that ball images don't overlap (with a pulse rate that is too high) or an insufficient number of ball images are obtained during an exposure (with a pulse rate that is too low). The distance to the (simulated) cup may also be used in accordance with principles of inventive concepts to adjust imaging parameters, such as IR strobe rate and duration.

The flow chart of FIG. 5 illustrates the process of analyzing a single exposure in which a plurality of ball images have been captured in flight in accordance with principles of inventive concepts. The process begins in step 500 and proceeds from there to step 502, where initial processing of the image is carried out. Initial processing may include the subtraction of a “pre-flight” image from an “in-flight” image. That is, in accordance with principles of inventive concepts, system 100 may form an image of the field of view of IR imager 316 immediately before the ball struck. This image may be triggered, for example, by a triggering device, such as previously described, or, in a retrofit implementation, may use an exit array trigger coupled to imager 316. This “pre-flight” image is subtracted from the “in-flight” image (by “in-flight” image, we are referring to the single exposure having a plurality of strobed ball images that track the ball's flight). In this manner, background imagery is suppressed, bringing the imagery of interest (that of the ball in flight) to the foreground.

After the initial processing of step 502, the process proceeds to step 504, where areas within the image that are likely to be balls are located. This step differentiates, at least to a first order, objects that are likely to be balls, white blobs on dark backgrounds, from other objects, such as a user's legs or a golf club.

From step 504 the process proceeds to step 506 where the system 100 locates smooth edges of the ball candidate and assigns a score indicative of the candidate's quality. This may be carried out in the presence of blurs from the golf club and ball movement that may occlude parts of the ball.

In step 508 the process locates reference marks, or fiducials, that have been placed on the ball to aid in analysis of the ball's flight characteristics. From step 508 the process proceeds to step 510 where a lens correction process is carried out to correct the fiducial and ball locations to remove lens distortion. In step 512, the candidate balls are ordered temporally and the system 100 determines which flash of the strobe created each of the candidate ball images. Because of interference, for example, from a user's leg or other object interfering, an image associated with a particular flash could be obscured and, as a result the system analyzes and associates each of the candidate images with the correct corresponding strobe flash.

In step 514 the distance between the centers of the ball in successive images is measured and the ball speed is derived from that measurement and the time between successive strobes. From step 514 the process proceeds to step 516 where the system creates a fiducial list for each ball/fiducial combination. This list employs a common coordinate system based on the center of the ball and ball size, so that calculations may be carried out between balls (that is, ball images) that are identical except for the location of fiducials. As will be described in greater detail below, each fiducial on a ball is “tracked” as it progresses from ball image to ball image in order to determine the angular velocity and direction of the ball.

In step 518 the system corrects for apparent rotation of the ball. Apparent rotation is the appearance of rotation due to the movement of the ball across the field of view of the camera 31x. This is akin to a car driving past a person who, first, sees the front of the car as it approaches, sees the side of the car as it is parallel to the person, then sees the rear of the car after the car has passed; the car isn't rotating, this is apparent rotation.

In step 520 a list of paired points is developed, whereby point on one ball image are matched up with the same point on another ball image.

In step 522 two pairs of matched points on different ball images are used to calculate the axis of rotation of the ball and the angular velocity of the ball. In accordance with principles of inventive concepts, a plurality of image pairs may be employed to enhance accuracy.

From step 522 the process proceeds to end in step 524.

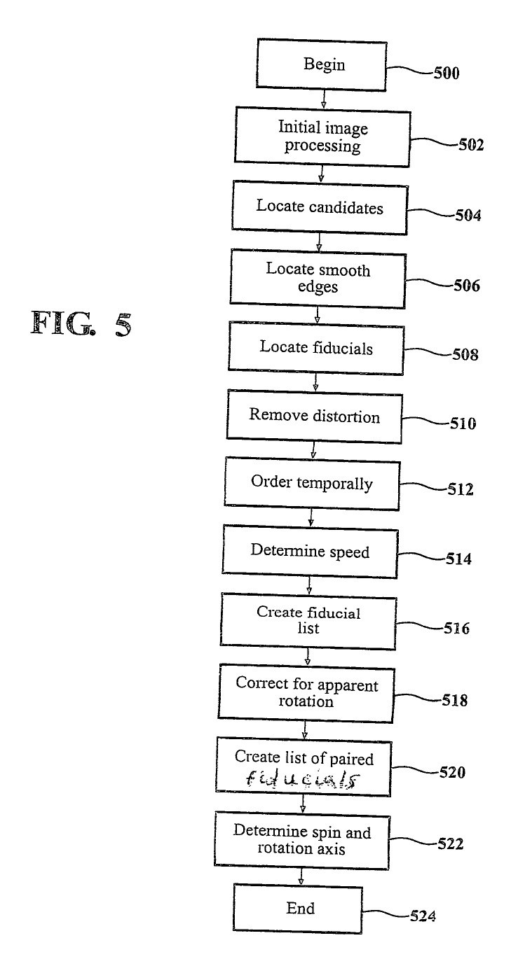

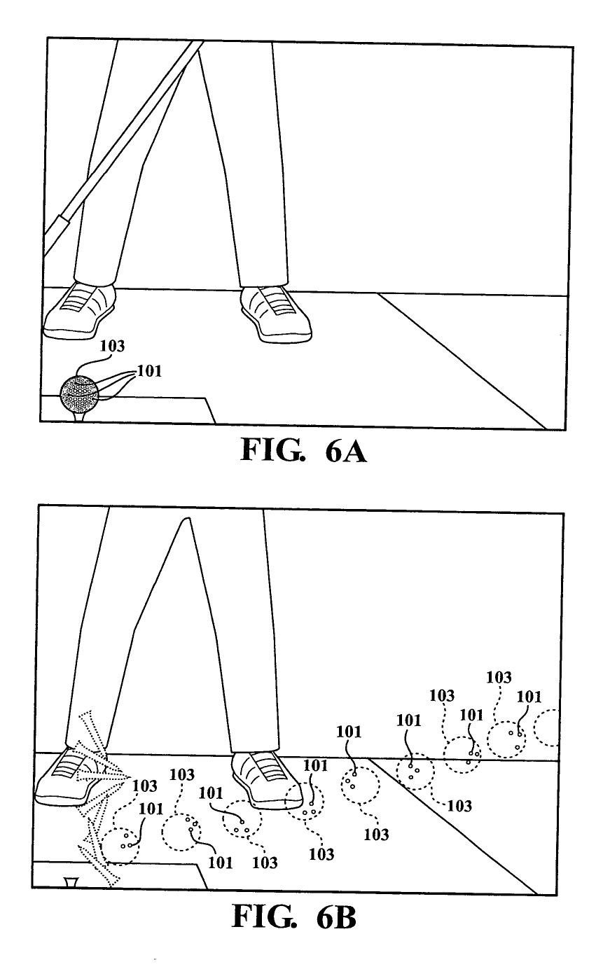

The images of FIGS. 6A through 6B illustrate the process of image subtraction in accordance with principles of inventive concepts as described in step 502 of the flow chart of FIG. 5. FIG. 6A is an image captured by system 100 of a golf ball on a tee just before being struck, a pre-flight image as previously described. Three fiducial marks 101 are seen on the golf ball 103 in FIG. 6A. FIG. 6B is an image captured by system 100 of a golf ball immediately after being struck, the in-flight image previously described. A plurality of golf ball images, created through illumination by IR strobe 314, are included in the single exposure captured by IR imager 316. Subtracting the image of FIG. 6A from the image of FIG. 6B substantially eliminates static components of the in-flight image, thereby ridding the image of background imagery and allowing the system to focus on the object of interest, the golf ball 103 in flight with movement of fiducial marks 101 used to determine flight characteristics as described in greater detail below.

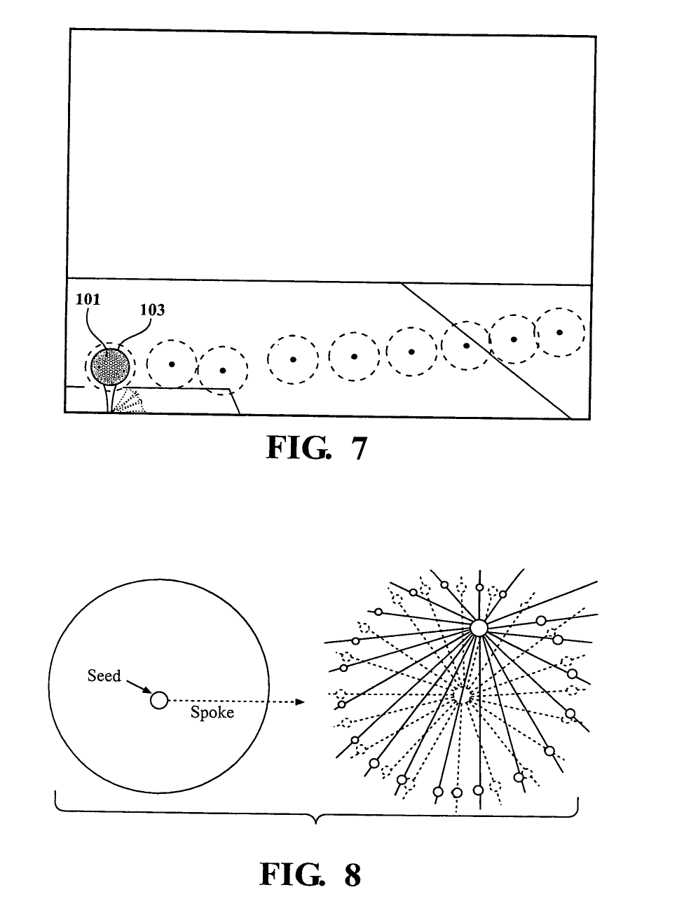

To locate candidate golf ball images, as described in the discussion related to step 504 of FIG. 5, system 100 may employ a process called “blob finding,” or blob detection. Blob finding is known and, in an example embodiment, blob detection may be performed using the SimpleBlobDetector class in the OpenCV computer vision library. SimpleBlobDetector uses an implementation of the Susuki contour finding algorithm to find contours and then groups the closed contours into “blobs”. Such contour finding is known and described, for example, in: Suzuki, S. and Abe, K., Topological Structural Analysis of Digitized Binary Images by Border Following. CVGIP 30 1, pp 32-46 (1985). FIG. 7 illustrates the system 100's use of blob detection to locate white “blobs” that approximate the size of a golf ball. Because the background has been subtracted, as previously described, the process of locating ball/blob image candidates is enhanced in accordance with principles of inventive concepts.

The location of smooth ball edges in accordance with principles of inventive concepts, as described in the discussion related to step 506 of FIG. 5, will now be described in greater detail in the discussion related to FIGS. 8 through 12.

Due to club blur, ball blur and background imagery, images typically lack a well-defined circular edge to define a ball. As a result, a system 100 in accordance with principles of inventive concepts may infer the ball center and radius by identifying/locating likely “good” edges of the ball. In accordance with principles of inventive concepts, edges may be identified, or formed, from a list of points found to be on the edge of a ball circle. A single point on the edge of the ball circle may be found by starting with a “seed” point within a ball circle candidate identified by system 100, the system 100 then generating a list of pixel values along a line radiating outward from the seed point and then the system operating (as described below) on the list of values to find where the “spoke” crosses the ball/background boundary, as illustrated conceptually in FIG. 8. For clarity, only two seed points are included in FIG. 8. In the actual implementation a system in accordance with principles of inventive concepts may employ several seed points to improve accuracy. With the idealized ball of FIG. 8, the pixel values for a single “spoke” proceeding outward from the seed would tally something like this: WHITE, WHITE, WHITE . . . WHITE, GRAY, GRAY, GRAY . . . .

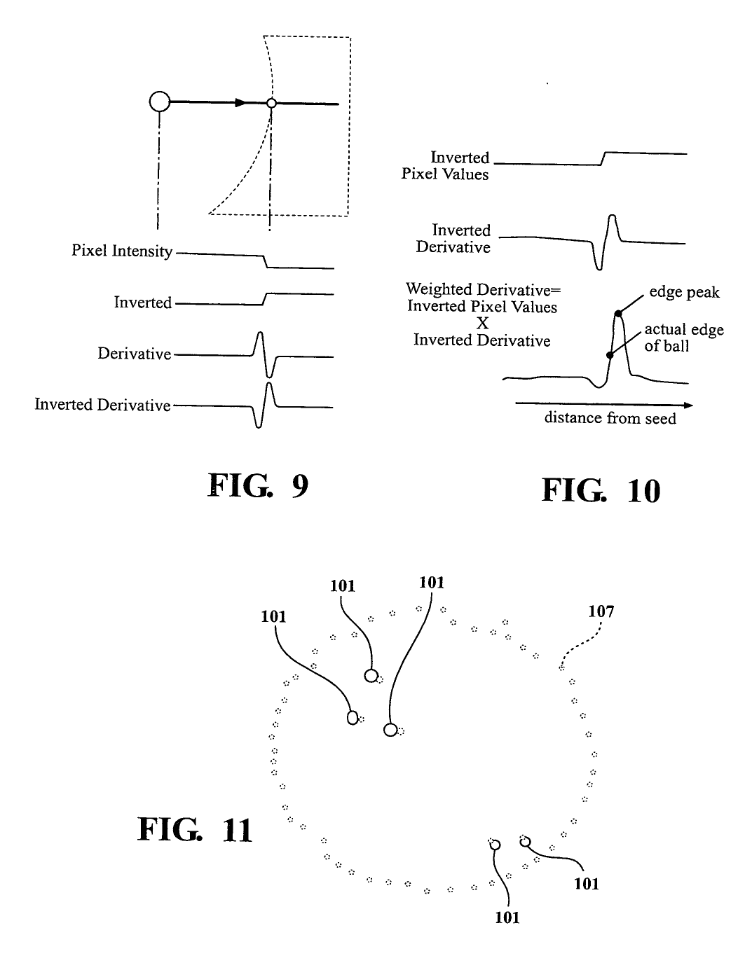

The conceptual diagram of FIG. 9 illustrates a process of edge detection in an example embodiment in accordance with principles of inventive concepts. The edge of the ball coincides with a large change in pixel intensity (white ball to dark background). The derivative of these values would show an upward spike followed by a downward spike at the transition from WHITE pixels to GRAY pixels.

Ball images captured by a system 100 in accordance with principles of inventive concepts are far from the simplicity of the idealized ball of FIG. 9, however. In operation, the ball is covered with shadows from the dimples as well as dark fiducial marks (marks which will be described in greater detail below) and other marks. As a result, there may be multiple light/dark and dark/light transitions along a given “spoke.”

To overcome this impediment, a system and method in accordance with principles of inventive concepts may produce a more accurate picture of where a ball's edge is by enhancing the ball edge. Recognizing that the derivative of the pixel values spike at a light to dark transition and that the background next to the ball is darker than the dark shadow the ball casts on itself, a system and method in accordance with principles of inventive concepts combines this information to accentuate, or “weight” the peaks that are closest to the edge of the ball, as illustrated, conceptually, in FIG. 10.

In accordance with principles of inventive concepts, inverting the pixel values (so dark becomes light) and then multiplying the resultant by the inverted derivative points, yields a set of values that has peaks where the ball transitions from light to dark near the edge of the ball. Using the peak location relative to the seed (distance from seed) and angle of the line from which the pixel values are taken, a 2D “edge point” is generated in accordance with principles of inventive concepts. In accordance with principles of inventive concepts, this process is repeated for a plurality of “spokes” and for a plurality of seeds until a cloud of points that are mostly on the edge of the ball is developed.

In example embodiments in accordance with principles of inventive concepts, images of golf ball edges, as determined by the process to this point, are smoothed to enhance circle/ball finding. As illustrated conceptually in FIG. 11, edges of a ball image determined by the previous steps may still exhibit an uneven, ill-defined profile. A system and method in accordance with principles of inventive concepts may determine runs of points 107 (for clarity, only one of which is labeled in FIG. 11) along an edge to form smooth polylines and, as a result, form a smooth-edged extraction of a ball representation (ball center and radius), which enhances the processes of determining ball launch angle, ball speed, ball spin rate and ball spin axis. As previously indicated, those values may then be employed in the simulation of a golf game or a training exercise, for example.

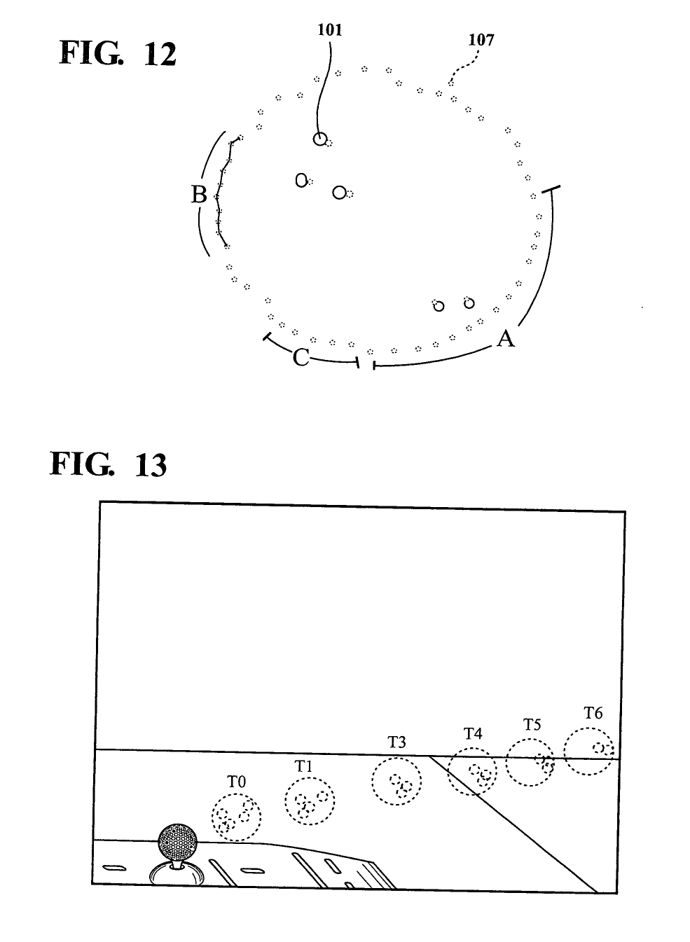

FIG. 12 illustrates a process of golf ball image edge-smoothing in accordance with principles of inventive concepts. Curves may be generated by ordering all the edge points counterclockwise around a point somewhere inside the ball image circle. The point inside the ball image circle need not be the actual center and, in fact, at this point in the process, the actual center may not be known. In example embodiments the seed points are radially arranged around the rough center (found using Blob Finding in a previous step) at equal intervals. The seed points are at fixed angular intervals but at different distances from the center within a prescribed “band” or “orbit” halfway between the ball center and the ball edge, plus or minus some random “noise.”

In accordance with principles of inventive concepts, the system generates an array, a list of radii, of the distances of these ordered points from the common point inside the ball image circle. The system then generates a second array that contains the second derivative of the “radii” array—the 2nd derivative shows the rate of change of the radius from point to point. A smooth curve will have a smaller second derivative than a bumpy one.

The system 100 breaks the edge point curve into sub-curves that have a second derivative within a range chosen by the system 100 for acceptable smoothness and which contain a “run” of at least a minimum number of points, again, as chosen by system to ensure acceptable smoothness. In an example embodiment in accordance with principles of inventive concepts, the minimum number of points in a “run” and the derivative value that ensured “acceptable smoothness” were determined through experimentation (empirically). It is a function of the number of seed points and the number of “spokes” used for edge finding. Conceptually, in FIG. 12, sub-curves A and C may qualify as sufficiently smooth, but sub-curve B may not, as determined by system 100 according to the degree of smoothness desired. In example embodiments, the 2D “edge points” of these sub-curves are input to a Chernov-Taubin circle finding function yielding a circle center and radius. The resulting circles are filtered for size (discarding circles that are too small or too big). Of the remaining circles that are within range, their corresponding sub-curve points are resubmitted to a Levenberg-Marquardt circle finding function to get a more accurate center and radius. If more than one circle is found associated with a particular “blob,” the circle with the highest “score” is used in subsequent processing. A circle's score may be determined by how many of the points in the filtered candidate curves lie on the circles edge along with some other criteria. This complete circle-finding operation is performed on both the subtracted background image and the in-flight image.

In example embodiments a system 100 in accordance with principles of inventive concepts may correct for lens distortion, as described in the discussion related to step 510 of FIG. 5. Such correction may be used for a user display, but, because corrected images may contain artifacts, lens-corrected images typically will not be used for image processing.

In the example in-flight image of FIG. 13 balls are ordered by time, in this example, times T0 through T6, as described in step 512 of FIG. 5. Each time index corresponds to a corresponding strobe flash and the ball speed may be calculated by taking the distance between ball image centers (in corrected image space) and dividing by the difference in time index to yield the number of pixels traveled during the strobe period, as briefly described in the discussion related to step 514 of FIG. 5. Using the known number of pixels per inch (with a fixed-distance camera), the speed may be converted from pixels per strobe period to miles per hour, for example. Various imaging effects may be accommodated in order to improve the accuracy of the ball's speed measurement in accordance with principles of inventive concepts. For example, because a ball away from the center of the imager's field of view will appear to have smaller inter-ball-image spacing, the apparent speed of the ball will vary with the distance from the center of the imager's field of view, increasing as the ball is farther from the center. To address this apparent speed artifact, because the apparent speed change is linear in nature, a system and method in accordance with principles of inventive concepts may fit a line to a list of X position and speed pairs and extrapolate back to the point of launch (using linear interpolation) to obtain the correct ball speed. For example, Given list of (pos,speed) “points”: (Xn,Sn), (Xn+1,Sn+1), (Xn+2,Sn+2) Find Speed at position X=Xteedball. The launch angle of a ball may be determined in accordance with principles of inventive concepts by determining the angle (in corrected image space) between two ball images.

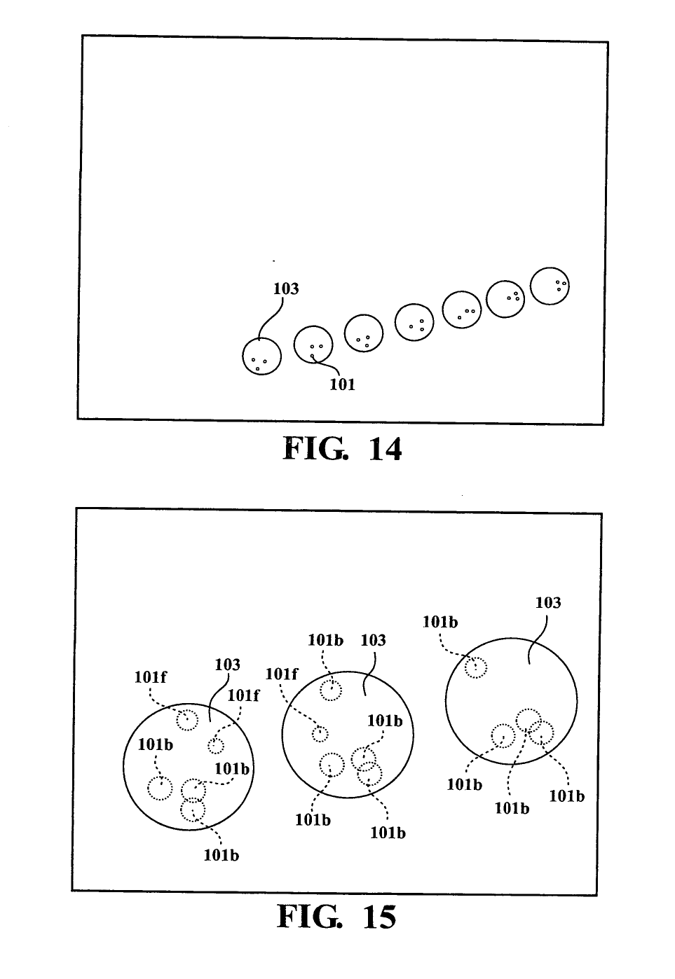

In example embodiments in accordance with principles of inventive concepts fiducial marks, or, simply, fiducials are placed on a ball in order to calculate flight characteristics such as spin, for example. Blob finding may be employed to locate fiducials on a ball. Similar to the way a system and method in accordance with principles of inventive concepts may employ blob finding to locate a lighter ball image in the context of a dark background, the system may employ blob finding to locate darker fiducials on the lighter background of a ball, with the non-ball elements of the image masked off. In accordance with principles of inventive concepts, blob finding may be performed on the masked off in-flight image and again on the masked off background-subtracted image. Fiducials are “scored” based on their contrast with the pixel values immediately surrounding the fiducial. FIG. 14 illustrates non-ball elements of the image masked off and FIG. 15 illustrates fiducials from both in-flight and images and background-subtracted images located on ball images, with different-sized circles denoting different (that is, in-flight 101f or background-subtracted 101b) origins.

A list of fiducials found on each image is merged into a list of unique fiducials. In case a fiducial has a duplicate (found in both images), the scores of the repeated fiducial are combined and assigned to one of the fiducials and the duplicate is removed from the list. These fiducials are then filtered by minimum score and assigned to a filtered and scored fiducials array.

A fiducial list is then created for each ball-image using a common coordinate system (placing the fiducials on a unit sphere). The ball circles and the filtered and scored fiducials are corrected for lens distortion and added to the ball information.

The corrected fiducial points are projected onto the ball (3D) and then they are normalized to a unit sphere, that is, the points are transformed (“mapped”) to the surface of a sphere of radius=1.0 with an origin centered at the center of the ball. This allows all the fiducials on all the balls (that is, ball images) to be processed with a common coordinate system.

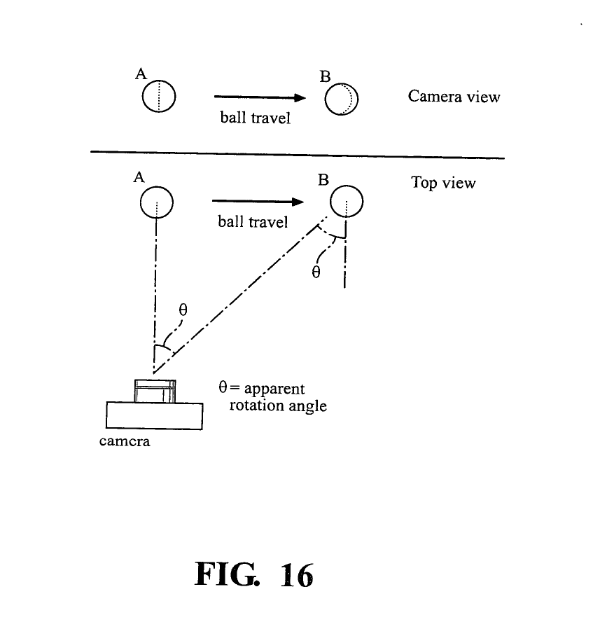

Apparent Rotation is the appearance of rotation due the ball moving past the camera, as illustrated in FIG. 16. As the ball moves past the imager, the imager first detects the front of the ball, then the side of the ball, then the rear of the ball as each element of the ball moves into the view of the imager. This apparent rotation is accounted for/removed in accordance with principles of inventive concepts before spin calculations are performed; the unit sphere fiducials are “de-rotated” before subsequent processing.

In order to calculate the ball's rotation, a system and method in accordance with principle of inventive concepts employs the path of at least two fiducials, tracked from one ball image to the next. The problem of finding the same fiducial across balls is what is called a “correspondence” problem—given a point on one image, find the corresponding point in another image. Because the golf balls are rotating in three dimensions, conventional planar homography and key point correspondence methods aren't applicable.

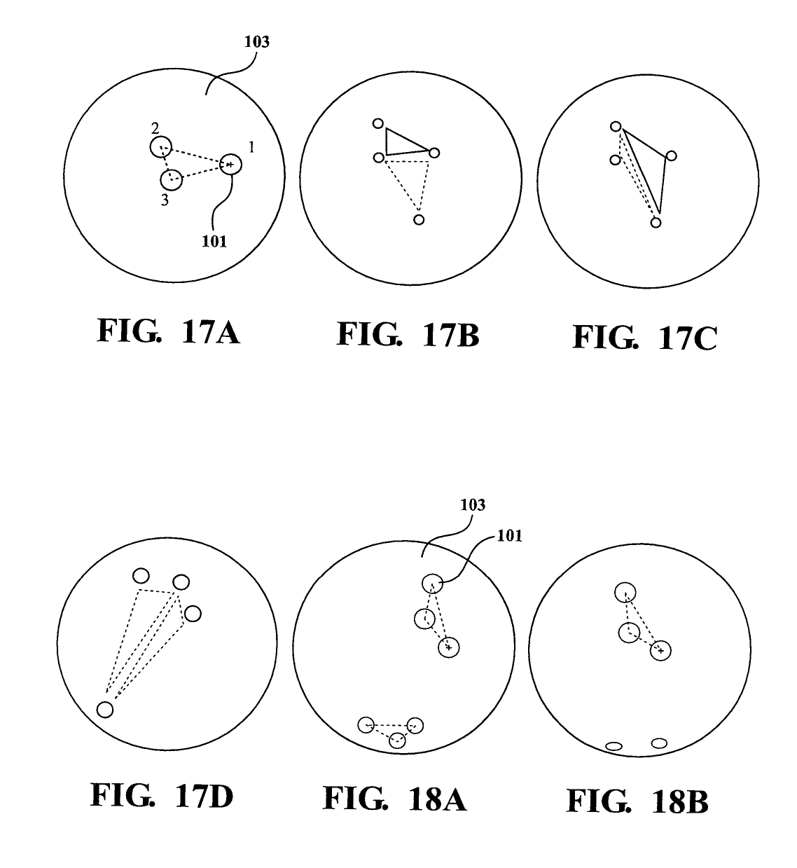

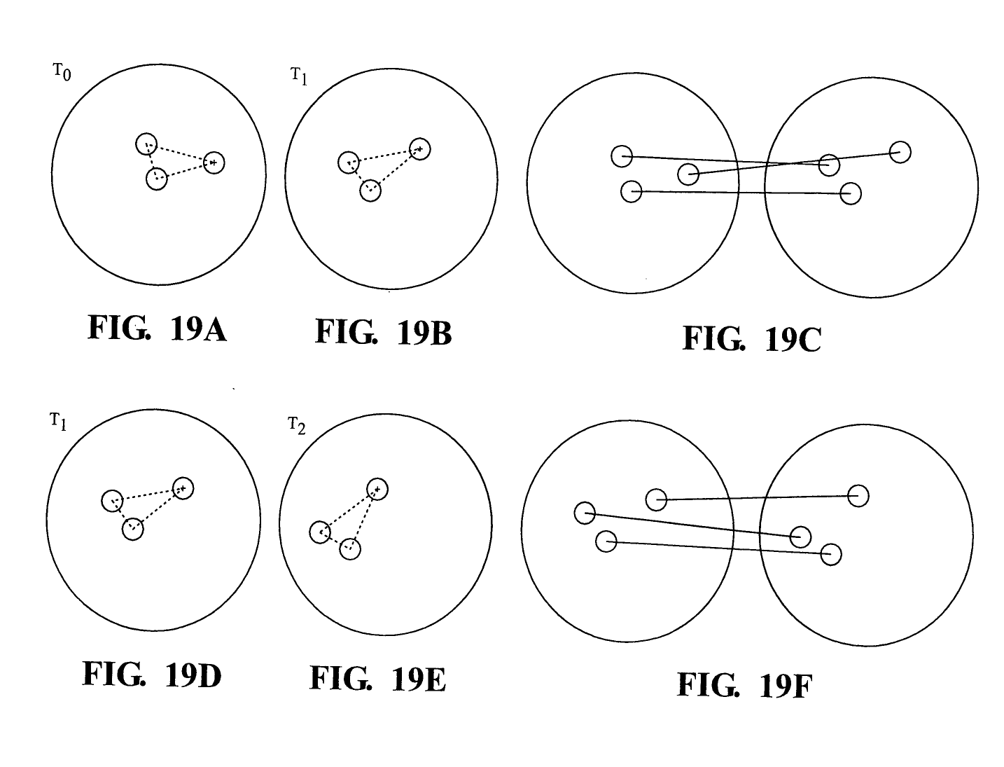

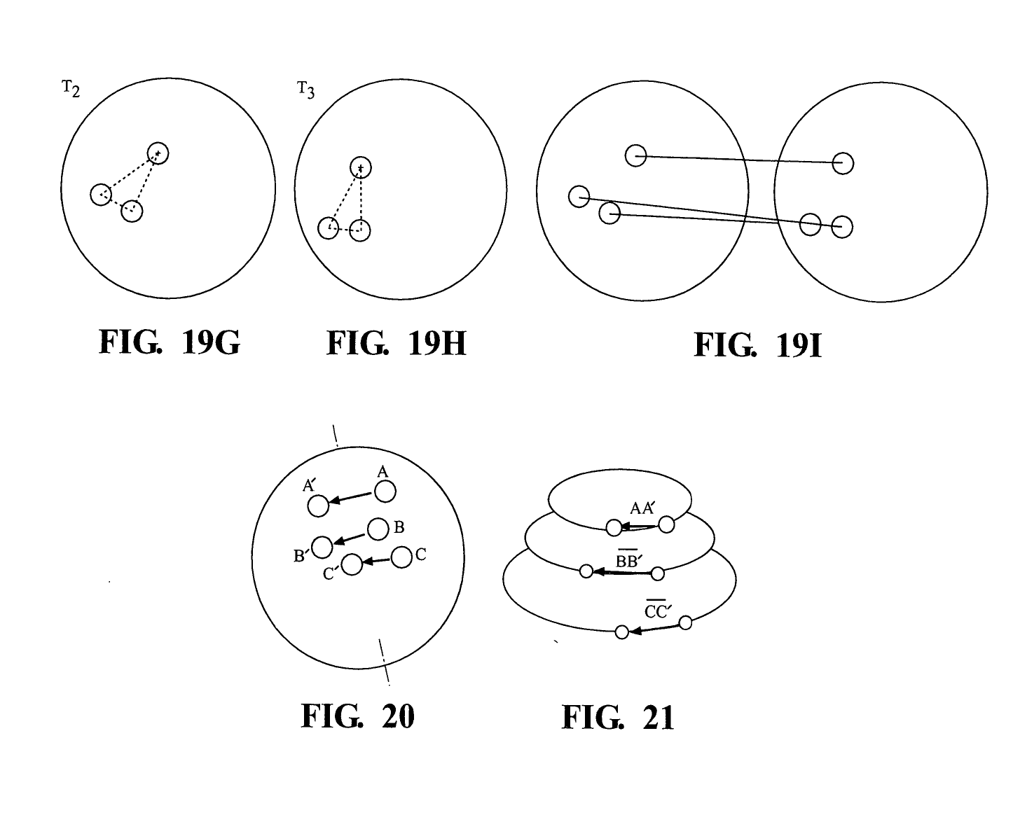

In accordance with principles of inventive concepts, a system and method in accordance with principles of inventive concepts creates geometric shapes, such as triangles, from fiducials, as illustrated in FIGS. 17A through 17D, which allow the matching and tracking of geometric shapes and, concomitantly, of fiducials among ball images. In FIGS. 17A through 17D reference numerals are included in FIG. 17A to identify a ball 102 and fiducial mark 101, but, for clarity, reference numerals are not included in the remaining figures. The same approach is used in FIGS. 18A and 18B and 19A through 19I. In previous steps, the fiducials were placed in a common reference space (on a unit sphere) and corrected for apparent rotation. Fiducials on two different ball images can't be matched directly, because they all look alike. But when placed in the context of arranged sets (for example, triangles) in accordance with principles of inventive concepts, they can be uniquely identified; fiducials can be identified by their relationship to an orientable triple of fiducials (“fiducial set”), as illustrated in FIGS. 17A through 17D.

Finding corresponding fiducials in accordance with principles of inventive concepts is a multistep process. First, a list of fiducial triples or “triangles” is created for each ball image in a pair of ball images. A system and method in accordance with principles of inventive concepts creates a list of all the possible triangles that can be formed on a ball using the fiducials as end points of connecting lines. A ball with three (visible) fiducials would have one possible triangle. A ball with four visible fiducials would have four possible triangles and a ball with five visible fiducials would have ten possible triangles. These point numbers are an index into the array of unit sphere fiducial points that was generated earlier for this particular ball image, not the actual 3D points themselves. As previously mentioned, the corrected fiducial points are projected onto the ball and then normalized. The point numbers referred to here are illustrated in the following table 3.

Given a ball with 4 fiducials and 2 good triangle candidates:

TABLE 3

| Fiducial/Point# | X_{2DCorrected} | Y_{2DCorrected} | X_{3DunitSphere} | Y_{3DunitSphere} |
|---|---|---|---|---|
| 0 | aa | bb | aaa | bbb |
| 1 | cc | dd | ccc | ddd |
| 2 | ee | ff | eee | fff |
| 4 | gg | hh | ggg | eee |

| Triangle # | Point #s (Fiducial # from previous table) |
|---|---|
| 0 | 3, 0, 1 |
| 2 | 0, 2, 3 |

In accordance with principles of inventive concepts, triangle candidates may be filtered, or selected, by eliminating triangles that cannot be uniquely tracked, and orientation determined, through a plurality of ball-images. For example, equilateral triangles, because their orientation may be difficult to uniquely identify, are eliminated from consideration. The size of a triangle, or length of a triangle's side(s) may also eliminate it from consideration. In operation, the minimal acceptable size may be determined empirically. Similarly, triangles with a side(s) longer than a maximum length may be eliminated from consideration, as the triangle points may be close to an edge (where determining their location is subject to greater error), or may include fiducials from different fiducial sets (that is, from equatorial and polar sets, for example. In this example embodiment, each fiducial set is a triple of three grouped points. A fiducial from a different set is a fiducial outside the group that contains includes two other fiducials in a set.

The triangle formed of fiducials 1, 2, and 3 in FIG. 17A is an acceptable candidate for use in ball flight characteristic determination in accordance with principles of inventive concepts. In FIG. 176 an equilateral triangle, which is unacceptable, is contrasted with a right triangle, which is acceptable. The size of the “thinner” obtuse triangle of FIG. 17C is too small, rendering it unacceptable. And the sides of both the obtuse triangles of FIG. 17D are too long, rendering both of them unacceptable as candidates. As indicated above, these criteria are used to ensure that the chosen triangles can be uniquely tracked through a plurality of ball images and may be implemented empirically, for example.

Of the triangles that qualify on these bases the triangle points in the list of triangle triples (3-tuples) are ordered such that the triangle is traversed in a counter clockwise order starting with the starting point of the longest side. In FIG. 17A, the longest side is P1->P2 and the starting point is point 1. The first two rules (minimum triangle area and longest side not longer than an upper limit) tend to limit the triangles found to intentional fiducial sets (three fiducial that are close together). Increasing the maximum allowable longest side will allow “incidental” triangles composed of points from two different fiducial sets to be used. If this is done, triangles should be pre-filtered to remove duplicates.

Given the list of “triangles” on each ball image, the triangles may be matched by similarity and, in example embodiments, triangles are matched according to similarity of area, similarity of perimeter length, and similarity of side proportions. For example, in the images of FIGS. 18A and 18B, let triangle A have side lengths of 7,3,3 and triangle B have side lengths of 6,4,3. The perimeter lengths of both of these triangles is the same 13 (7+3+3=6+4+3) and for purposed of illustration, assume their areas are similar. In accordance with principles of inventive concepts, different methods may be employed to judge the similarity of side length proportions. For example, a system may treat the side lengths as components of a normalized 3D vector and project one vector on to the other using the dot product. A perfect match will have a result=1.0. A minimum tolerance (0.98) may be used to determine if the triangles are similar. Or a system may normalize the side lengths and perform a member wise subtraction and sum the differences. The closer to zero, the more similar the match is. Once the triangles are paired up, the ordering rules applied earlier (that is, sides are oriented in counter-clockwise order starting with the longest side) allow fiducial correspondence to be determined.

As illustrated in the conceptual diagram of FIG. 19, given two similar triangles with sides visited in the same order, the first point of the longest side line of one triangle is going to correspond to the first point of the longest side on the second triangle (indicated by the heavier lines within triangles on the left side of FIG. 19). Given this, fiducials from one ball image may be mapped to corresponding fiducials of another ball image obtained at a different strobe time, as indicated by the mapping on the right side of FIG. 19.

To determine the ball spin, as discussed in relation to step 522 of the flow chart of FIG. 5, in accordance with principles of inventive concepts the axis of rotation of the ball may be determined then the rotation for fiducial pairs may be determined. In order to determine the axis of rotation, having established fiducial correspondence, as previously illustrated, for example, in the discussion related to FIG. 19A-19I, the axis of rotation and spin may be determined by a system 100 in accordance with principles of inventive concepts. In FIG. 19A-19I, for example, three rows of unit spheres illustrate point-to-point (that is, fiducial-to-fiducial) correspondence over a period from time T0 to time T3. The two leftmost spheres in each row (for example, FIGS. 19A and 196) illustrate fiducials arranged in triangle-sets, with associated movement during a unit time period: from time T0 to time T1, from time T1 to time T2, and from time T2 to time T3, in this illustrative embodiment. The two rightmost spheres in each row (for example, FIG. 19C) illustrate the corresponding fiducial-to-fiducial mapping during the same time periods.

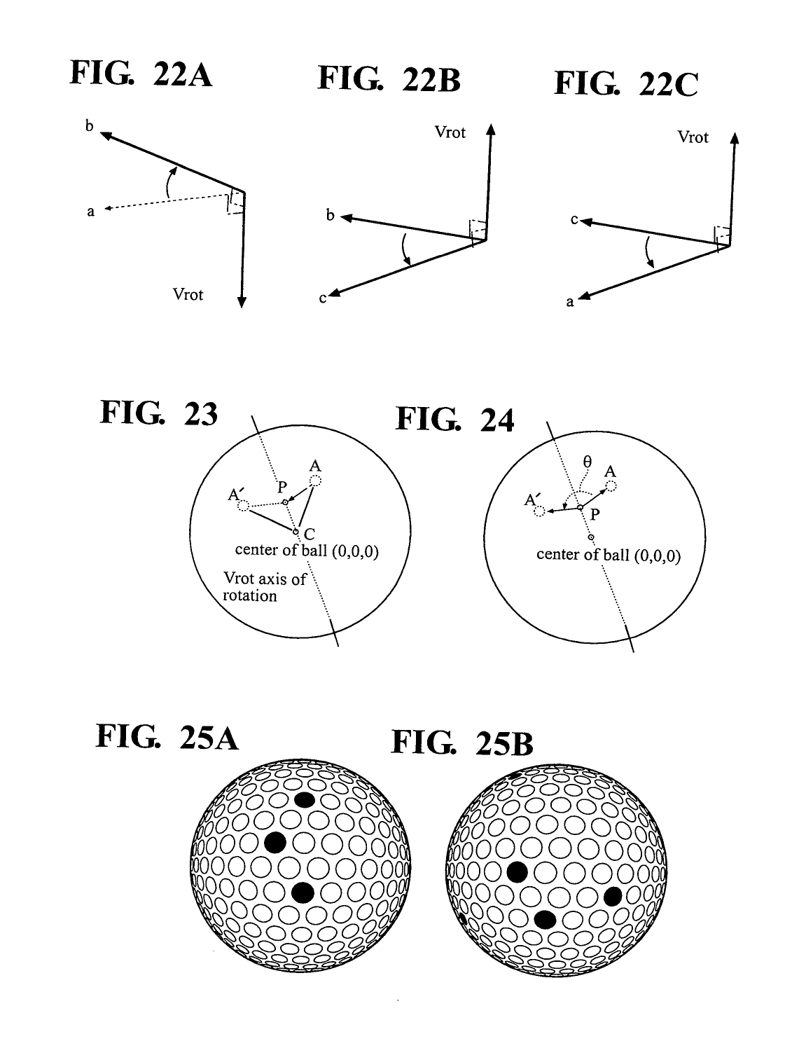

Referring to FIG. 20, fiducials on the same ball, must necessarily rotate around the same axis and rotate the same amount. This also means that matching points lie on a plane perpendicular to the axis of rotation. All the point pairs lie on planes perpendicular to the same axis of rotation, as illustrated in FIG. 21. If the lines are treated as vectors [a=A′−A], the cross product of any two of these vectors will yield another vector that is perpendicular to both vectors, yielding the axis of rotation Vrot, as illustrated in FIG. 22. Taking the cross product of two vectors yields an axis of rotation vector but the order of the vectors [(a×b) vs (b×a)] affects the sign of the vector. Depending on the order, some rotation axis will point “backwards” and some will point in the correct direction. This is accounted for in later processing.

In example embodiments a system in accordance with principles of inventive concepts calculate rotation for each fiducial pair. As illustrated in FIG. 23, to calculate the angle of rotation, in an example embodiment a system 100 in accordance with principles of inventive concepts projects the fiducial onto the axis of rotation to get point P.

Next, as illustrated in FIG. 24, the system 100 creates 2 vectors, one from point P to point A [symbol] . Another from point P to point A′ [symbol] . Since the points are on a unit sphere, the length of [symbol] and [symbol] are both equal to 1.0. The unsigned angle, theta, between these vectors is calculated using the dot product:

θ_{rotA}=cos⁻¹( [symbol] · [symbol] ) Equation 1:

Theta equals the inverse cosine of the dot product of vector [symbol] and

[symbol]

The correct axis of rotation VcorrectRotA, with the correct sign/direction is then calculated from the vectors PA and PA′ using the cross product.

V_{correctRotA}= [symbol] × [symbol] (The cross product of two vectors.) Equation 2:

Perform a similar operation to calculate the rotation and rotation axis for the other fiducials using the following equations:

θ_{rotB}=cos⁻¹( [symbol] · [symbol] ) Equation 3:

θ_{rotC}=cos⁻¹( [symbol] · [symbol] ) Equation 4:

V_{correctRotB}= [symbol] × [symbol] Equation 5:

V_{correctRotC}= [symbol] × [symbol] Equation 6:

Given three fiducials, a process in accordance with principles of inventive concepts may potentially yield three (slightly) different axis of rotations and 6 rotation values, as illustrated in table 1:

TABLE 1

| | | | Rotation |
|---|---|---|---|
| Fiducial Pair | Axis of Rotation | Rotation of 1^{st} Fiducial | of 2^{nd} Fiducial |
| A & B | V_{correctRotA} | θ_{rotA0} | θ_{rotB0} |
| B & C | V_{correctRotB} | θ_{rotB1} | θ_{rotC0} |
| C & A | V_{correctRotC} | θ_{rotC1} | θ_{rotA1} |

Sample values obtained in accordance with principles of inventive concepts are set forth in table 2:

TABLE 2

| | | Rotation of | Rotation |
|---|---|---|---|
| | | 1^{st} Fiducial | of 2^{nd} Fiducial |
| Fiducial Pair | Axis of Rotation | (degrees) | (degrees) |
| A & B | <−0.161, −0.788, −0.594> | 26.683 | 26.942 |
| B & C | <0.264, 0.581, −0.770> | 27.016 | 28.644 |
| C & A | <0.217, 0.507, −0.834> | 28.134 | 27.384 |

In accordance with principles of inventive concepts, the axis from the set with the most similar fiducial rotations may be selected as the Axis of Rotation and the rotation is the average of the rotations for that pair. (Average of 26.683 and 26.942=>26.812).

In an example embodiment in accordance with principles of inventive concepts, if three or less solutions are found, the final axis+rotation answer is an average. If more than three solutions are found, the answer is the average after eliminating the solutions with the smallest and largest rotations.

TABLE 3

| Balls used for rotation | | Angle |
|---|---|---|
| calculation | Axis of Rotation (Vᵣₒₜ) | of Rotation (degrees) |
| 3 => 4 | −0.161, −0.788, −0.594 | 26.812 |
| 4 => 5 | −0.135, −0.857, −0.497 | 25.161 |
| Average | −0.148, −0.823, −0.545 | 25.986 |

At this point, in an example embodiment, a system has developed an axis of rotation in 3D image space in terms of pixels with a rotation per strobe period. These values may be converted, for ease of use, as follows:

Convert the rotation to RPM according to:

$${Spin}_{RPM} = \frac{( rotationInDegreesPerStrobe \times strobeFrequency )}{6.0} \qquad Equation 7$$

Convert the spin values to backspin.

SpinTimesUnitAxisOfRotation=Spin_{RPM}×Vᵣₒₜ Equation 8:

BackSpinAxis=<0,0,−1> Equation 9:

SideSpinAxis=Vᵣₒₜcross<0,0,1> Equation 10:

BackSpin_{RPM}=SpinTimesUnitAxisOfRotation·BackSpinAxis (Dotproduct) Equation 11:

SideSpin_{RPM}=SpinTimesUnitAxisOfRotation·SideSpinAxis (Dotproduct) Equation 12:

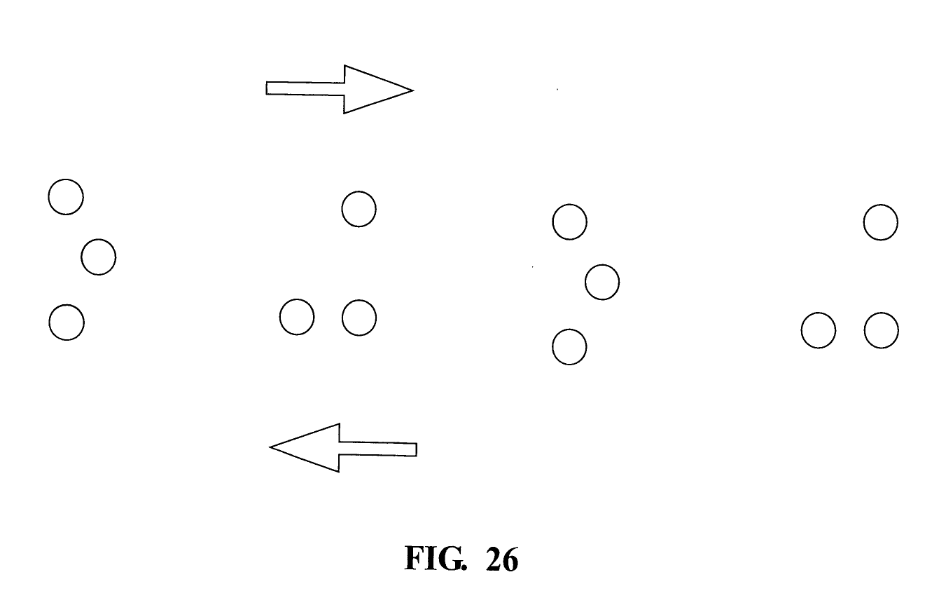

In example embodiments in accordance with principles of inventive concepts, fiducials of a predetermined pattern are placed on a golf ball in order to allow system 100 to readily identify the patterns. In an example embodiment, the pattern of fiducials illustrated in FIG. 25A is repeated four times around the “equator” of the golf ball, spaced approximately ninety degrees apart. And the pattern of FIG. 25B is formed on the “poles” of the golf ball. In the illustrative embodiment in accordance with principles of inventive concepts of FIG. 26, four fiducial sets in the form of three-point triangles represent the equator of the ball and arrows are positioned in the polar regions, with the arrow on top of the ball pointed in the direction of intended ball travel.

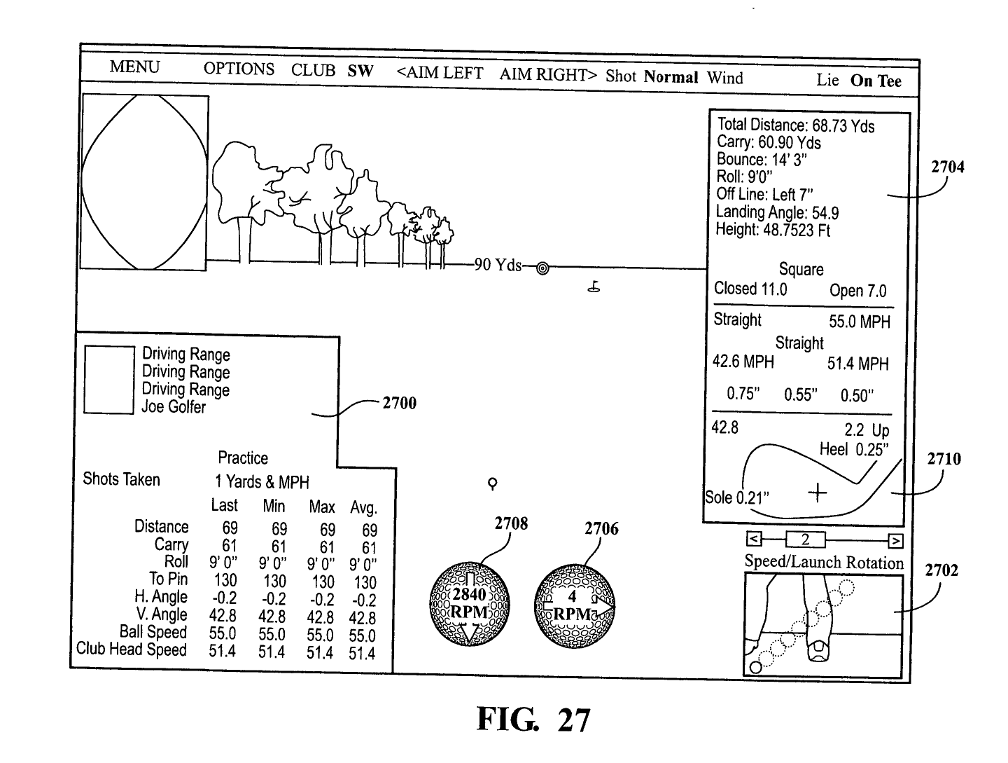

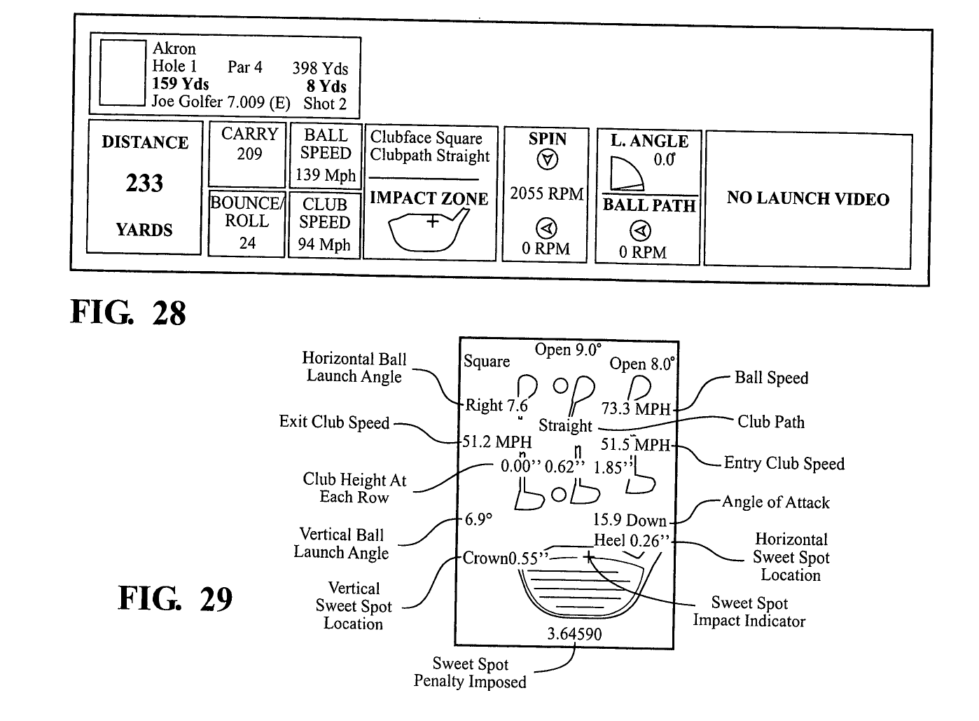

In the example screenshot of FIG. 27 a system in accordance with principles of inventive concepts is operating in a driving range mode and displays fields that include a log 2700 of shots taken, an image of a strobed ball in-flight 2702, and a field 2704 that provides information to the golfer indicative of club orientation and ball information. The image 2702 may include indications as to whether the system was able to successfully calculate ball flight characteristics, as previously described. Fields 2706 and 2708 may provide a user with ball spin, displayed as backspin and sidespin, respectively. Club head information, which may be obtained using a conventional system, such as that described in U.S. Pat. No. 6,821,211, may be displayed as in field 2710, for example. In example embodiments in accordance with principles of inventive concepts, a system 100 may display ball spin in a variety of ways. For example, a user may choose to have ball spin displayed in a “combined” manner, with a single axis and rate of rotation displayed, or in a “split” manner, with backspin and sidespin broken out separately. In the example embodiment of FIG. 27 the left ball image illustrates backspin (with spin rate) and the right ball image illustrates side spin direction, with spin rate. Ball speed and launch angle information is listed in fields 2700 and 2704. In this example embodiment, the launch angle is given as 42.8 and 55.0 mph is the ball speed. The ball spin and speed may be employed in accordance with principles of inventive concepts, along with other elements, such as the layout of a particular course or driving range to develop results such as distance, carry, roll, distance to pin, and horizontal and vertical angles, for example, as listed in field 2700. In example embodiments a system in accordance with principles of inventive concepts may provide to a user a textual output that only shows the textual value of all readings, a full graphical interface such as illustrated in FIG. 27, or a simplified graphical interface such as that of FIG. 28, for example.

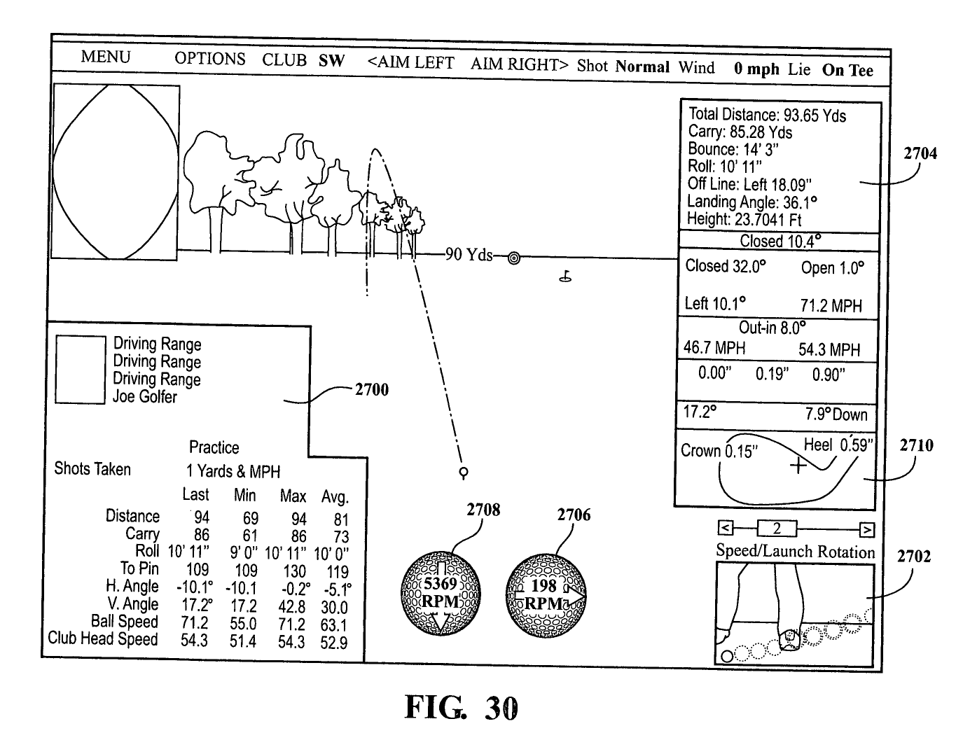

FIG. 29 provides a detailed view of information such as may be displayed in field 2704. The view of FIG. 29 may be implemented as a popup view with textual description of the featured information. In FIG. 30 a display indicates that the rotation information has not been computed accurately, by virtue of the different background color of the “rotation” field in the lower right corner. The ball speed and launch angle were successfully calculated, though, as indicated by the background color of the “Speed/Launch” field in the lower right corner. If the system 100 is unable to calculate a value successfully, a default calculation, based on club data may be employed. Such calculations may be based, for example, on a system employing platform 200 and methods such as described in U.S. Pat. No. 6,821,211, which is hereby incorporated by reference.

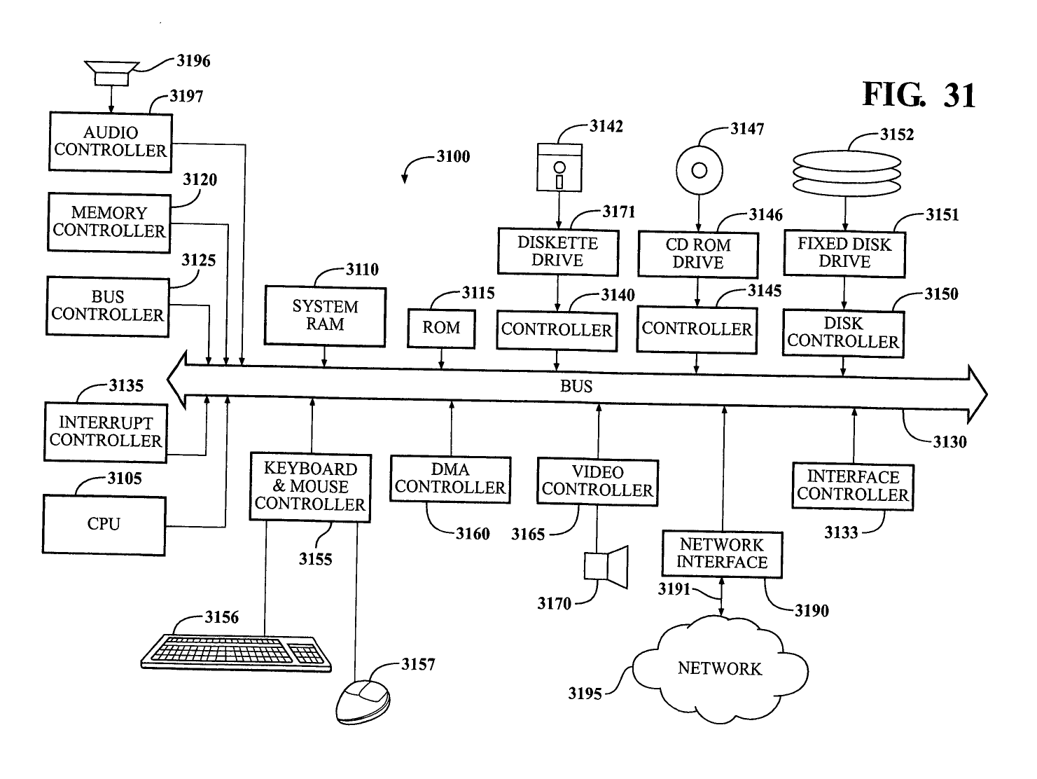

FIG. 31 illustrates the system architecture for a computer system 3100 on which a portion of the invention may be implemented. The exemplary computer system of FIG. 31 is for descriptive purposes only. Although the description may refer to terms commonly used in describing particular computer systems, the description and concepts equally apply to other systems, including systems having architectures dissimilar to FIG. 31.

Computer system 3100 includes a central processing unit (CPU) 3105, which may be implemented with a conventional microprocessor, a random access memory (RAM) 3110 for temporary storage of information, and a read only memory (ROM) 3115 for permanent storage of information. A memory controller 3120 is provided for controlling RAM 3110.

A bus 3130 interconnects the components of computer system 3100. A bus controller 3125 is provided for controlling bus 3130. An interrupt controller 3135 is used for receiving and processing various interrupt signals from the system components.

Mass storage may be provided by diskette 3142, CD ROM 3147, or hard drive 3152. Data and software may be exchanged with computer system 3100 via removable media such as diskette 3142 and CD ROM 3147. Diskette 3142 is insertable into diskette drive 3141 which is, in turn, connected to bus 3130 by a controller 3140. Similarly, CD ROM 3147 is insertable into CD ROM drive 3146 which is, in turn, connected to bus 3130 by controller 3145. Hard disc 3152 is part of a fixed disc drive 3151 which is connected to bus 3130 by controller 3150.

User input to computer system 3100 may be provided by a number of devices. For example, a keyboard 3156 and mouse 3157 are connected to bus 3130 by controller 3155. An audio transducer 3196, which may act as both a microphone and a speaker, is connected to bus 3130 by audio controller 3197, as illustrated. It will be obvious to those reasonably skilled in the art that other input devices, such as a pen and/or tabloid may be connected to bus 3130 and an appropriate controller and software, as required. DMA controller 3160 is provided for performing direct memory access to RAM 3110. A visual display is generated by video controller 3165 which controls video display 3170. Computer system 3100 also includes a communications adaptor 3190 which allows the system to be interconnected to a local area network (LAN) or a wide area network (WAN), schematically illustrated by bus 3191 and network 3195. An input interface 3199 operates in conjunction with an input device 3193 to permit a user to send information, whether command and control, data, or other types of information, to the system 3100. The input device and interface may be any of a number of common interface devices, such as a joystick, a touch-pad, a touch-screen, a speech-recognition device, or other known input device.

Operation of computer system 3100 is generally controlled and coordinated by operating system software. The operating system controls allocation of system resources and performs tasks such as processing scheduling, memory management, networking, and I/O services, among things. In particular, an operating system resident in system memory and running on CPU 3105 coordinates the operation of the other elements of computer system 3100. The present invention may be implemented with any number of operating systems, including commercially available operating systems. One or more applications, such may also run on the CPU 3105. If the operating system is a true multitasking operating system, multiple applications may execute simultaneously.

Although various example embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Further, the methods of the invention may be achieved in either all software implementations, using the appropriate object or processor instructions, or in hybrid implementations that utilize a combination of hardware logic, software logic and/or firmware to achieve the same results. The specific configuration of logic and/or instructions utilized to achieve a particular function, as well as other modifications to the inventive concept are intended to be covered by the appended claims.

The foregoing description of specific embodiments of the invention has been presented for the purposes of illustration and description. It is not intended to be exhaustive or to limit the invention to the precise forms disclosed, and many modifications and variations are possible in light of the above teachings. The embodiments were chosen and described to best explain the principles of the invention and its practical application, and to thereby enable others skilled in the art to best utilize the invention. It is intended that the scope of the invention be limited only by the claims appended hereto.

What is claimed is:

1. An apparatus comprising:
a strobe device configured to illuminate a ball in flight;
an imaging device configured to capture an image of the illuminated ball in flight; and
a processor configured to determine a flight characteristic of the ball in flight from the captured image.

2. The apparatus of claim 1, further comprising:
a triggering device to detect motion related to the flight of the ball and to trigger the strobe device and imaging device.

3. The apparatus of claim 1, wherein the strobe device is configured to illuminate the ball using electromagnetic radiation outside the visible spectrum.

4. The apparatus of claim 1, wherein the flight characteristic is one from among: ball velocity, ball launch angle, and ball spin.

5. The apparatus of claim 1, wherein the processor is further configured to simulate the flight of the ball along a path beyond a field of view of the imaging device.

6. The apparatus of claim 5, wherein the processor is further configured to simulate a game using the simulated flight of the ball.

7. The apparatus of claim 1, wherein the processor is configured to determine the speed of the ball from a plurality of strobe images of the ball captured in one frame of the imaging device.

8. The apparatus of claim 1, wherein the processor is configured to determine the angular velocity and axis of rotation of the ball from a plurality of strobe images of the ball captured in one frame of the imaging device.

9. The apparatus of claim 8, wherein the processor is configured to employ fiducial marks on the ball in the plurality of strobe images of the ball captured in one frame of the imaging device to determine the angular velocity and axis of rotation of the device.

10. A method, comprising:
illuminating a ball in flight with a strobe device;
capturing an image of the strobe-illuminated ball in flight with an imaging device; and
a processor determining a flight characteristic of the ball in flight from the captured image.

11. The method of claim 10, further comprising:
a triggering device detecting motion related to the flight of the ball and triggering the strobe device and imaging device.

12. The method of claim 10, wherein the strobe device illuminates the ball using electromagnetic radiation outside the visible spectrum.

13. The method of claim 10, wherein the processor determines a flight characteristic of the ball from among: ball velocity, ball launch angle, and ball spin.

14. The method of claim 10, wherein the processor simulates the flight of the ball along a path beyond a field of view of the imaging device.

15. The method of claim 14, wherein the processor simulates a game using the simulated flight of the ball.

16. The method of claim 10, wherein the processor determines the speed of the ball from a plurality of strobe images of the ball captured in one frame of the imaging device.

17. The method of claim 10, wherein the processor determines the angular velocity and axis of rotation of the ball from a plurality of strobe images of the ball captured in one frame of the imaging device.

18. The method of claim 17, wherein the processor employs fiducial marks on the ball in the plurality of strobe images of the ball captured in one frame of the imaging device to determine the angular velocity and axis of rotation of the device.

19. A golf system, comprising:
an infrared strobe device configured to illuminate a golf ball in flight;
an infrared imaging device configured to capture a plurality of images of the illuminated ball in flight within one frame of the imaging device; and
a processor configured to determine the speed of the golf ball in flight from the plurality of captured images by temporally organizing the captured images and associating the times of the captured images with times of the infrared strobe to establish a time difference between captured images, determining the pixel distance between captured images, and employing the pixel distance and time difference to determine the speed of the ball.

20. The golf system of claim 19, wherein the processor is further configured to correct for lens distortion, for apparent speed shift of the ball as it moves through the imaging device's field of view, and for apparent rotational shift of the ball as it moves through the imaging device's field of view.
